(19) United States
(12) Patent Application Publication
(10) Pub. No.: US 2023/0185964 A1
(43) Pub. Date: Jun. 15, 2023

(54) MASKING DEVICE, MASKING METHOD, AND MASKING PROGRAM

(71) Applicant: Nippon Telegraph and Telephone Corporation, Tokyo (JP)

(72) Inventors: Shiro OGASAWARA, Musashino-shi, Tokyo (JP); Takeshi MASUDA, Musashino-shi, Tokyo (JP); Yuki URABE, Musashino-shi, Tokyo (JP); Fumihiro YOKOSE, Musashino-shi, Tokyo (JP); Hidetaka KOYA, Musashino-shi, Tokyo (JP)

(21) Appl. No.: 17/925,429

(22) PCT Filed: May 29, 2020
(86) PCT No.: PCT/JP2020/021498

§ 371 Date: Nov. 15, 2022

(51) Int. Cl. G06F 21/62; G06F 9/451

(52) U.S. Cl. CPC G06F 21/6254; G06F 9/451

(57) ABSTRACT

A masking apparatus identifies a screen and screen components included in individual screen data of first screen data serving as a reference and one or more pieces of second screen data serving as a processing target. In addition, the masking apparatus specifies third screen data on a basis of the screen and the screen components that are identified, the third screen data being data equivalent to the first screen data in the one or more pieces of second screen data. In addition, the masking apparatus determines necessity of masking of each screen component included in the first screen data on a basis of the third screen data.

### TECHNICAL FIELD

The present disclosure relates to a masking apparatus, a masking method and a masking program.

### BACKGROUND ART

1. Screen Data

### 1.1. Screen Data of Program

In a terminal operation, a worker refers to values indicated in a text box, a list box, a button, a label and the like (hereinafter referred to as “screen component”) that make up the screen of the program that operates in the terminal, and performs operations such as input and selection of values for the screen component. Therefore, some programs intended for automation or support of the terminal operation, determination and analysis of the operation conditions acquire and use all or part of the screen image, the attributes (title, class name, coordinate value of display region, displayed program name, and the like) of the screen, and the information about the screen components (hereinafter they are collectively referred to as “screen data”) illustrated in FIG. 1.

The information about the screen components can be obtained by UI Automation (hereinafter referred to as “UTA”), Microsoft Active Accessibility (hereinafter referred to as “MSAA”), or program's own interface. The information about the screen components includes relationship information (hereinafter referred to as “screen structure”) such as the inclusion relation and possession relationship of screen components internally held in the program, as well as information that can be used with each screen component alone (hereinafter referred to as “attribute”) such as the type, the display/non-display status, the display value, and the coordinate value of the display region of the screen component.

In screens that are displayed at different time points and different terminals, the values of the attributes of some of screen components differ depending on the displayed case and/or the operation implementation status even when the function provided to the worker is the same (hereinafter referred to as “equivalent”). In addition, the presence/absence of the screen components itself also differs. For example, when the number of items included in the case differs, the number of rows of the list indicating the times differs. Alternatively, the display/non-display of the error message may change depending on the implementation status of the operation. Thus, the screen structure varies.

1.2. Usage of Screen Data

### 1.2.1. Usage as Screen Data of Small Number of Samples

In the program intended for automation or support of the terminal operation, such as that disclosed in PTLs 1 and 2, in operation setting, screen data as a sample is acquired at a specific terminal, and the display value is acquired and the screen component as the operation target (hereinafter referred to as “control target”) is designated by using the data. At that time point when executing the automation or support process, the screen data (hereinafter referred to as “processing target screen data”) displayed on any terminals including terminals other than the specific terminal whose operation setting has been performed is acquired, and it is cross-checked with the sample screen data, a screen obtained by processing the sample screen data, or the determination condition of the equivalence of the screen components. In this manner, from the screen data at that time point, screen components equivalent to the screen components of the control target in the sample screen data are specified, and set as a target of acquisition and operation of the display value.

For this reason, the sample screen data is required for execution of the automation or support process. In addition, the sample screen data is also required when visual display is performed for manually checking and changing the details of the operation setting. Therefore, programs intended for automation or support of terminal operations keep sample screen data retained, regardless of whether the sample screen data is centrally located on a shared server or on each terminal that executes the automation or support process.

### 1.2.2. Usage as Screen Data in Large Number of Operation Logs

In the program intended for determination and analysis of the actual business conditions, screen data and information about the operation is acquired at the timing when the worker performs the operation on a screen component at each terminal, and collected as an operation log. In order to manually determine and analyze the patterns and trends, the large amount of collected operation logs are categorized and used for aggregation according to the part of the information about the case to be operated that is included in the screen data as the display value of the screen components, for example, the type of case such as new/changed/canceled, the type of targeted product or service, the region, and the period.

1.3. Confidential Information in Screen Data

The screen may display case information to be processed, and handling of some of the case information, such as customer information, including referring, needs to be performed only by a minimum number of people, or only by a few authorized people (hereinafter referred to as “confidential information”).

The sample screen data held as operation settings by a program intended for automating or supporting terminal operations includes the details of the screen display at the time of operation setting as the display values of the screen components, and therefore may also include confidential information. As illustrated in FIG. 2, it is necessary to remove, non-specify, generalize, or crop (hereinafter referred to as “masking”) the confidential information so that the original values cannot be understood while the names of the data items and the values of the data items used to determine the conditions in the automation and support processes are left as they are so that the automation and support processes can be executed and the operation settings can be checked and changed.

In addition, the screen data of the operation log collected for the purpose of determining and analyzing the actual business conditions may also contain confidential information. It is necessary to mask the confidential information while enabling the determination and analysis of the actual business conditions.

Here, information with many variations in which the value differs depending on the case of the screen display target and the like is information that can directly specify customers and the like, and is therefore tends to be confidential information in many cases. On the other hand, information that has less variations and has the same value among multiple cases is information that makes it difficult to directly specify customers and the like, and is therefore tends to be not confidential information in many cases.

On the other hand, the operation setting of the program intended for automation or support of the terminal operation needs to be repeatedly applicable to various cases, and therefore information that less depends on the case of the screen display target and has less variations is used. In addition, also in classifying information in the process of understanding and analyzing actual business conditions, information with little variations is used so that the number of classifications does not become too large.

Therefore, if the display values of screen components that can only have a limited number of candidate values are not to be subjected to masking, and those that can have any values are to be subjected to masking, it will be possible to automate and support terminal operations, determine and analyze actual business conditions, and limit the handling of confidential information.

2. Masking Method

### 2.1. Masking Method not Based on Usage of Screen Data

When screen data contains information about screen components, it is conceivable to use a method for checking whether the type of screen component is a type such as a list box for which the display value can only have limited candidate values, or a type such as a text box for which the display value can have any values, and masking the screen components for which the display value can have any values.
2.2. Masking Method in Case where Masking of Only Sample Screen Data is Performed
When the sample screen data does not contain information about the screen components, a method for masking is used in which the creator of the operation setting designates the region of the screen image that requires masking of the display values, and then the designated region is blacked out.

Alternatively, when the sample screen data contains information about screen components, a masking method is used in which the creator of the operation setting designates the screen component whose display value needs to be masked, and the display value of the designated screen component is masked by replacing it with a predetermined character string such as “****” or a randomly generated character string, and in addition, on the basis of the coordinate values of the display region of the screen component, the region where the screen component is drawn in the screen image is specified and masked.

2.3. Masking Method in Case where Screen Data in Operation Log is Masked
Before collecting the operation log, the screen data of the screen on which the confidential information is displayed is obtained to serve as a sample, and the screen components to be subjected to masking are manually designated in the sample screen data.

In collecting operation logs, it is conceivable to use a method in which whether the processing target screen data acquired at that time is equivalent to the sample screen data is determined, and those that are equivalent to the screen components to be subjected to masking in the sample screen data are specified from among the screen components of the processing target screen data, such that masking of the display values and masking of the regions in the screen image where the screen components are drawn are performed.

Alternatively, if it is difficult to limit the screens on which confidential information is displayed, the screen data of the screen that displays information required for determining and analyzing the actual business conditions is obtained to serve as a sample, and the screen components not to be subjected to masking is manually designated in the sample screen data.

In collecting operation logs, it is conceivable to use a method in which whether the processing target screen data acquired at that time is equivalent to the sample screen data is determined, and those that are equivalent to the screen components not subject to masking in the sample screen data are specified from among the screen components of the processing target screen data, such that for other screen components, masking of the display values and masking of the regions in the screen image where the screen components are drawn are performed.

Alternatively, it is conceivable to use a method in which after collecting the operation logs, the screen data to be used as a sample is selected from the collected operation logs, the screen components to be subjected to masking or not to be subjected to masking are manually designated for the sample screen data, whether the processing target screen data in the collected operation logs is equivalent to the sample screen data is determined, screen components to be subjected to masking or not to be subjected to masking in the sample screen data is specified from the screen components of the processing target screen data, and then the masking is performed based on the result.

3. Method for Specifying (Identifying) Components

In either method, as illustrated in FIG. 3, it is necessary to determine whether the screen data of the processing target and the sample are equivalent, and to specify (hereinafter referred to as “identify”) those that are equivalent to the screen components in the sample screen data from the processing target screen data.

As the identification method, PTLs 1 and 2 disclose a method (related-art identification technique A) of identifying screen components in programs whose screens are written in HTML, by means of tags and their HTML attributes corresponding to the types of screen components that are subjected to acquisition of display values and operations (hereinafter referred to as “control targets”). This method makes use of the fact that in equivalent screen components in equivalent screens there are attributes whose values do not change (hereinafter referred to as “invariant attributes”) regardless of the time or the terminal for acquisition of the screen data, and that screen components in the screen can be uniquely specified by invariant attributes or combinations of them.

In addition, NPL 1 discloses a method (related-art identification technique B) of using information about the tags and their attributes corresponding to the type of screen components to be controlled, as well as the tags and the attributes of the ancestors of the screen components to be controlled, in a screen structure composed of a directed ordered tree for programs whose screens are similarly described in HTML.

As an identification method for general programs, including those whose screens are not written in HTML, PTL 3 discloses a method (related-art identification technique C) in which as a condition for determining the equivalence of the screen components to be controlled, an “arrangement pattern” that expresses the conditions for the relative positional relationship of the screen components on a sample screen (two-dimensional plane) is prepared, and the screen components are identified by finding screen components that satisfy the arrangement pattern in the processing target screen.

The above description assumes that whether each screen component in the sample screen data is to be subjected to masking is manually determined, but if this can be automatically performed, the time and effort required for manual designation can be reduced.

PTL 4 discloses a method (related-art method for determining the type of screen component) for determining whether the display value of a screen component can have only limited candidate values or can have any values on the basis of a large number of operation logs.

### CITATION LIST

### Patent Literature

[PTL 1] JP 2009-99015A
[PTL 2] JP 2017-72872A
[PTL 3] JP 2018-77763A
[PTL 4] JP 2018-185564A

### Non Patent Literature

[NPL 1] W3C Recommendation 21 Mar. 2017, XML Path Language (XPath) 3.1

### SUMMARY OF THE INVENTION

### Technical Problem

However, the problems with known methods are that they may not be possible to properly specify the screen components to be subjected to masking, with less tasks. The problems are described below for each known method.

4. Problems

4.1. Problems with Masking Method not Based on Usage of Screen Data
Among the screen components, labels and text boxes (especially those that are for display only and cannot be edited) such as item names, are fixed regardless of the case to be displayed and are used to display values with little variation, while they are also used to display values with many variations, such as voucher numbers, customer codes, and business system user names that are automatically numbered by the program running in the terminal or managed internally. As such, whether the display value of the screen component can have only a limited candidate value or can have any value cannot be properly determined based on the type of the screen component alone.
4.2. Problems with Method of Masking of Only Sample Screen Data
It is necessary to manually specify all screen components or regions on the screen image that require masking of display values, which requires a lot of time and effort.
4.3. Problems with Method of Masking Screen Data in Operation Log
In the case where sample screen data is prepared before acquiring operation logs, it is necessary to have a good understanding in advance of what screens are used in terminal operations in the business operation to be grasped and analyzed, but it is rare to have a good understanding in advance in a situation of trying to grasp and analyze actual business conditions using operation logs. Alternatively, in the case where the sample screen data is prepared after operation logs are acquired, a lot of time and effort are required to select the required screen data from the large amount of operation logs such that the data required to be grasped and analyzed can be retained.

In addition, even when sample screen data can be selected, it is necessary to manually designate all screen components to be subjected to masking or not to be subjected to masking, which requires a lot of time and effort. The related-art screen component type determination technique can determine whether the display value of the screen component can only have a limited candidate value or can have any value on the basis of a plurality of operation logs. However, even with the equivalent screen, when the screen structures differ, a method for specifying screen components that are equivalent to each other among screen data in operation logs acquired at different time points and different terminals during the acquisition of variations of the display values is unknown, and currently, this technique can only be applied to the case where the equivalent screens have the exact match screen structure.

In addition, even if the screen component to be subjected to masking or not to be subjected to masking is designated as a control target in the sample screen data, the related-art identification techniques A to C may not be able to correctly specify the equivalent screen component from the processing target screen data.

In general programs, including those whose screens are not written in HTML, even when information about screen components can be acquired, there may be only few invariant attributes, and in some cases only the type of screen component. Therefore, based on an attribute or a combination of a plurality of attributes, each screen component cannot be uniquely identified in the screen in some cases. For example, in a screen written in HTML, for a text box, a list box, a button and the like of the input form, each screen component may be uniquely identified within the screen by tags, id attribute, name attribute, or a combination of these, but attributes of screen components that can be acquired by MSAA or UTA do not have such attributes (even if there is an “ID” or an attribute similar thereto, its value is valid only for that terminal and that time point, and cannot be used for unique identification because it will have a different value when the equivalent screen component is displayed on a different device and at a different time). For such a screen, the related-art identification technique A cannot identify the screen and the screen component.

In addition, in screen structures composed of directed ordered trees, pieces of the identification information are the same among a plurality of screen components even with use of the identification information using attributes of the screen component of the control target and its ancestor, and the related-art identification technique B cannot identify screens and screen components in many cases as illustrated in FIG. 4. In order to avoid this, it is possible to add conditions regarding siblings and descendants in the related-art identification technique B. However, currently, it is necessary to manually determine and add the required conditions for each screen or screen component, assuming the possible variations that may occur in the processing target screen.

On the other hand, in the related-art identification technique C, which is intended for general programs, the relative positional relationship of screen components on the screen (two-dimensional plane) may vary depending on the size of the screen and the amount of displayed content. For example, as illustrated in FIG. 5, when the width of the screen is reduced, the button that has been adjacently placed on the right side is separately placed on the lower left side. For such a program, the related-art identification technique C cannot identify the screen or the screen component. In addition, a method for automatically creating arrangement patterns used to identify the processing target screen from the relative positional relationship of the screen components designated at the time of operation setting in the sample screen (two-dimensional plane) is unknown, especially, a method for determining reflection of the relative positional relationship in the sample screen in the condition of the relative positional relationship based on how the relative positional relationship in the sample screen should be reproduced in the processing target screen is unknown. Currently, a person needs to create each screen and screen component, while assuming the possible variations that may occur in the processing target screen.

### Means for Solving the Problem

To solve the above-described problems and achieve an object, a masking apparatus includes an identification unit that identifies a screen and screen components included in individual screen data of first screen data serving as a reference and one or more pieces of second screen data serving as a processing target, a specifying unit that specifies third screen data on a basis of the screen and the screen components that are identified, the third screen data being data equivalent to the first screen data in the second screen data, and a determination unit that determines necessity of masking of each screen component included in the first screen data on a basis of the third screen data.

### Effects of the Invention

According to the present disclosure, a screen component to be subjected to masking can be appropriately specified with less tasks.

### BRIEF DESCRIPTION OF DRAWINGS

FIG. 1 is a diagram illustrating an example of screen data.

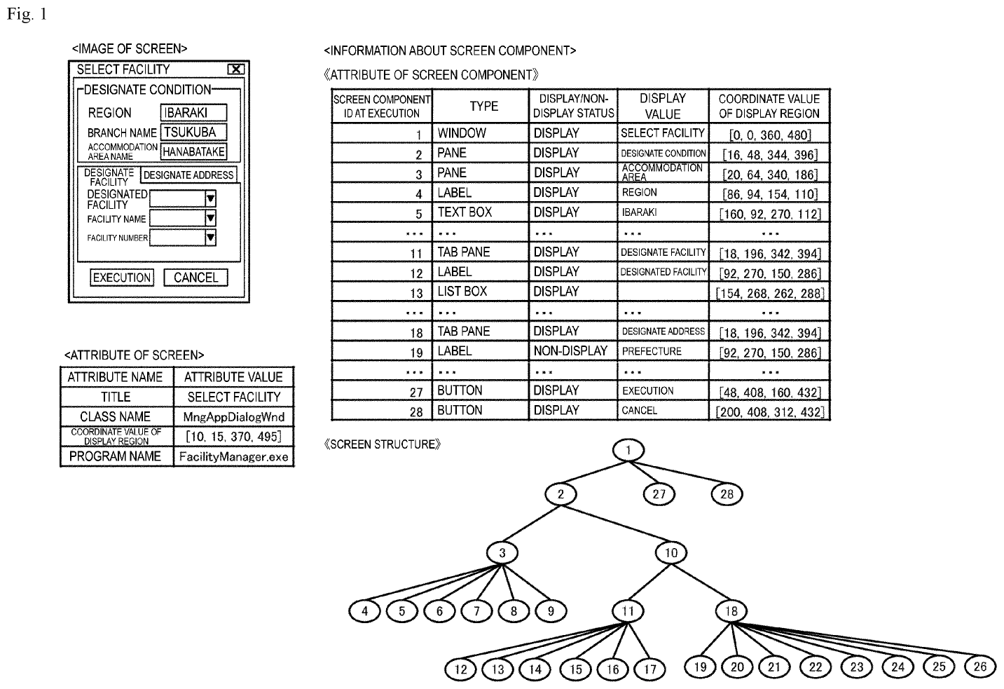

FIG. 2 is a diagram illustrating an example of masking.

FIG. 3 is a diagram illustrating a method for identifying screen component.

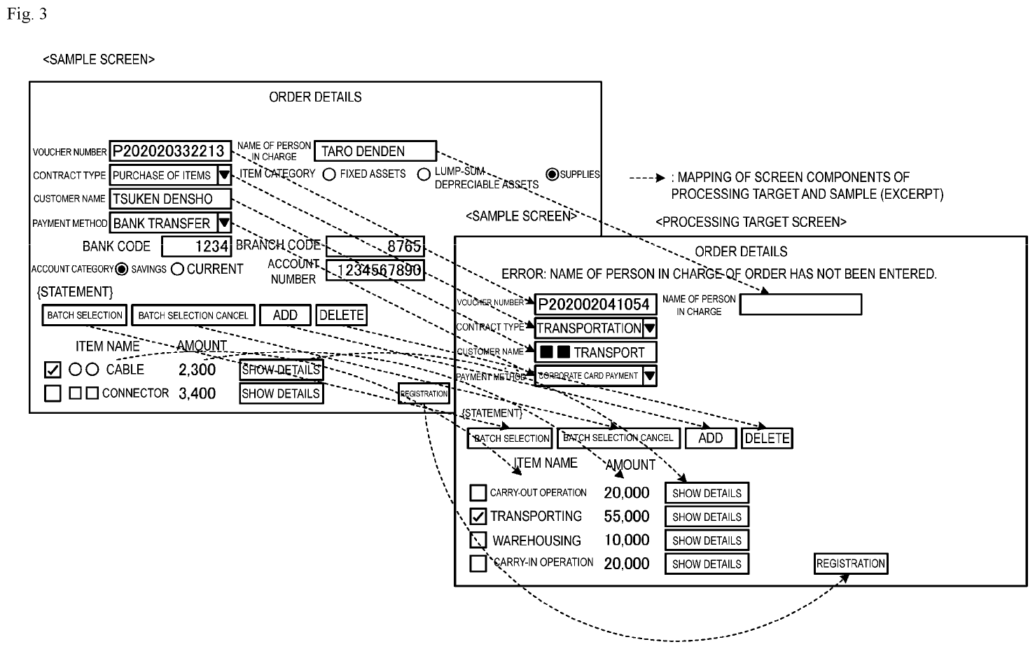

FIG. 4 is a diagram illustrating an example of a case where a screen component cannot be identified.

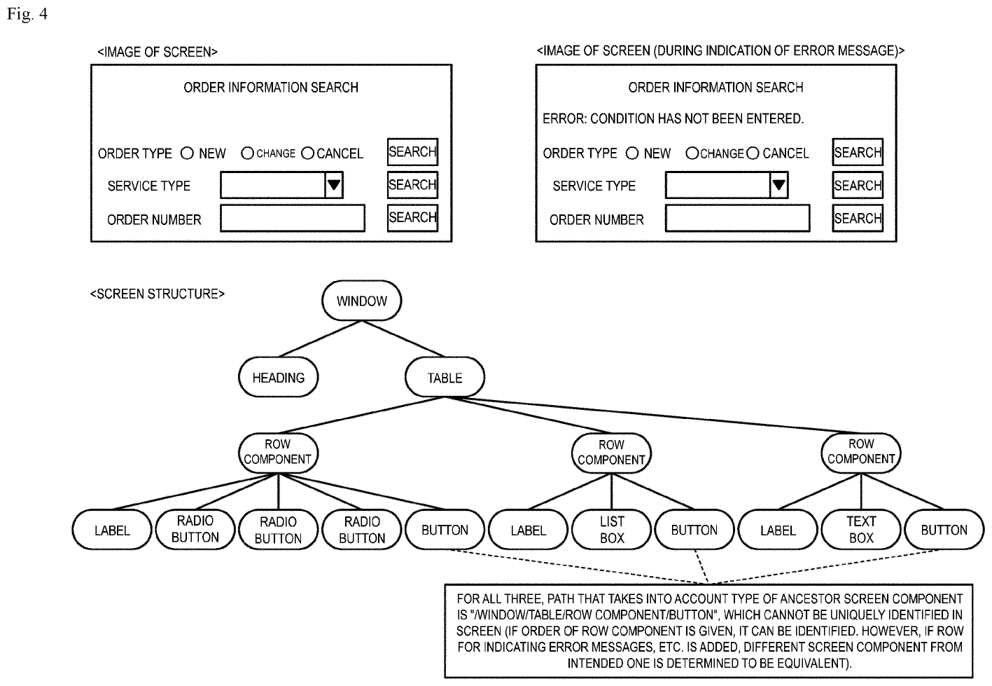

FIG. 5 is a diagram illustrating an example in which a relative positional relationship of a screen component is changed.

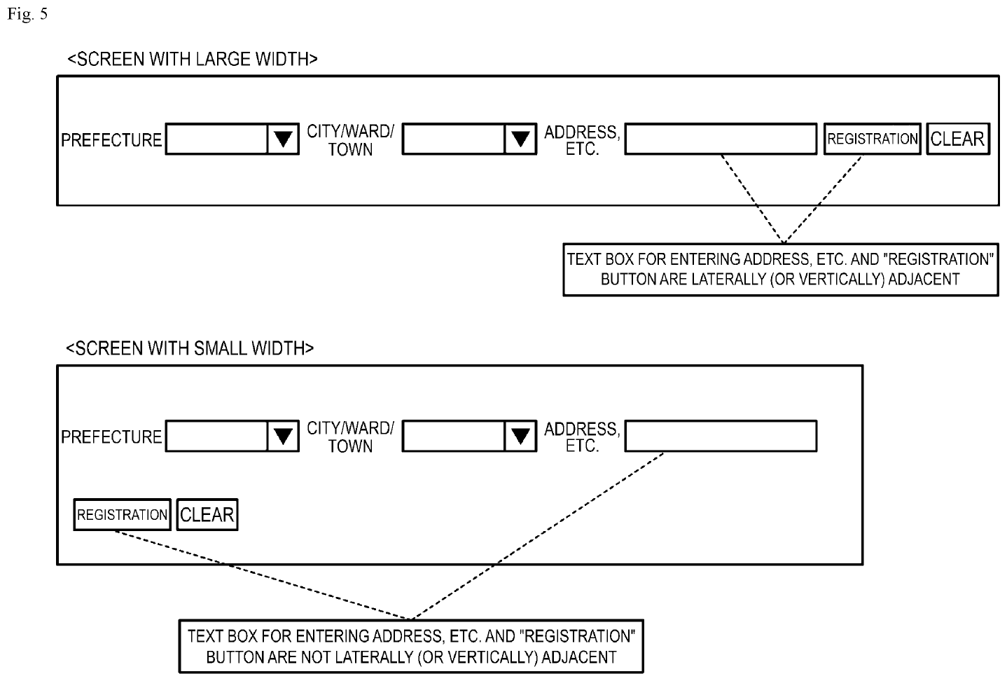

FIG. 6 is a diagram illustrating an example of a result of equivalence determination with a common partial structure with a best evaluation of a mapping method.

FIG. 7 is a diagram illustrating an exemplary configuration of a masking apparatus (use case (α)).

FIG. 8 is a diagram illustrating an exemplary configuration of a masking apparatus (use case (β)).

FIG. 9 is a diagram illustrating an example of data held by a sample screen data holding unit.

FIG. 10 is a diagram illustrating an example of data held by a processing target screen data accumulation unit.

FIG. 11 is a diagram illustrating an example of data held by an identification result holding unit (use case (α)).

FIG. 12 is a diagram illustrating an example of data held by an identification result holding unit (use case (β)).

FIG. 13 is a diagram illustrating an example of data held by a masking necessity determination target screen data list result holding unit (use case (α)).

FIG. 14 is a diagram illustrating an example of data held by a masking necessity determination target screen data list result holding unit (use case (β)).

FIG. 15 is a diagram illustrating an example of data held by a screen component display value list result holding unit.

FIG. 16 is a diagram illustrating an example of data held by a masking necessity determination result holding unit.

FIG. 17 is a diagram illustrating an example of data held by a screen comparison rule holding unit.

FIG. 18 is a diagram illustrating an example of data held by a screen component attribute comparison rule holding unit.

FIG. 19 is a diagram illustrating an example of data held by a screen data classification result holding unit.

FIG. 20 is a flowchart of an entire masking process (use case (α)).

FIG. 21 is a flowchart of an entire masking process (use case (β)).

FIG. 22 is a flowchart of an entire process of identifying a screen and a screen component (use case (α)).

FIG. 23 is a flowchart of an entire process of identifying a screen and a screen component (use case (β)).

FIG. 24 is a flowchart of a process of comparing a screen structure.

FIG. 25 is a flowchart of a process of evaluating a mapping method.

FIG. 26 is a flowchart of a process of determining the equivalence of screen structures.

FIG. 27 is a flowchart of an entire process of listing screen data to be subjected to a masking necessity determination (use case (α)).

FIG. 28 is a flowchart of an entire process of listing screen data to be subjected to a masking necessity determination (use case (β)).

FIG. 29 is a flowchart of an entire process of listing a display value of a screen component (use case (α)).

FIG. 30 is a flowchart of an entire process of listing a display value of a screen component (use case (β)).

FIG. 31 is a flowchart of an entire process of determining the necessity of masking.

FIG. 32 is a flowchart of an entire process of classifying screen data.

FIG. 33 is a diagram illustrating an example in which the similarity between screen data groups is determined from an identification result between screen data.

FIG. 34 is a diagram illustrating an example of classifying screen data.

FIG. 35 is a diagram illustrating an example of selecting a representative of a group.

FIG. 36 is a diagram illustrating an example of a computer that executes a masking program.

### DESCRIPTION OF EMBODIMENTS

An object of an embodiment is to appropriately specify a screen component to be subjected to masking in a screen, with less tasks.

The embodiment achieves masking of screen components under the first to fifth conditions described below where it is difficult to perform the masking of the screen components with related-art methods. Specifically, in the first condition, whether the display value of the screen component can only have a limited candidate value, or can have any values cannot be properly determined on the basis of the type of the screen component alone. The second condition is a condition where even with equivalent screens, the attribute value of the screen component and the screen structure vary depending on the displayed case and/or the operation implementation status. The third condition is a condition where the invariant attribute is limited to the type of the screen component and the like in the screen component information that can be acquired, and each screen component cannot be uniquely identified in the screen even by using the screen component to be subjected to masking or not to be subjected to masking and the attribute of its ancestors or a combination of a plurality of attributes. The fourth condition is a condition where the arrangement of screen components on a two-dimensional plane varies depending on the size of the screen and/or the volume of the display content of each screen component. The fifth condition is a condition where the determination condition of the equivalence of the screen component to be subjected to masking or not to be subjected to masking need not necessarily be manually created for each screen and/or each screen component. Note that each of the above-described conditions is a condition where masking is difficult. Therefore, naturally, in the case where none of the above conditions are met, or the above conditions are only partially met, the masking according to the embodiment can be achieved.

### EMBODIMENT

A masking apparatus, a masking method and a masking program according to an embodiment of the present application are described below with reference to the drawings. The present disclosure is not limited to embodiments that will be described below.

The masking apparatus of the embodiment mainly performs operations in accordance with two types of use cases. A case where masking of only sample screen data is performed is referred to as a use case (α). In addition, a case where masking of screen data in an operation log is performed is referred to as a use case (β). Note that the masking apparatus may support both the use case (α) and the use case (β), or one of them.

Overview of Operation in Use Case (α)

In the use case (α), during an operation at an initial stage where users are limited, such as operation confirmation after the creation of the operation setting of the program intended for automation or support of the terminal operation, the masking apparatus compares sample screen data and a plurality of pieces of screen data of the processing target acquired by the program intended for automation or support of the terminal operation, to thereby identify the screen and the screen component, and determine all equivalent screen data. The masking apparatus further determines, for each sample screen component, the number of equivalent screen components in other equivalent screen data and a variation of a display value and compares them with predetermined threshold values, thereby determining whether to perform masking and performing the masking.

In addition, in the identification of the screen and the screen component, the masking apparatus determines the equivalence of the screen and the screen component also in consideration of whether the relationship with other screen components in respective screen structures is the same between the screen component (hereinafter referred to as “sample screen component”) in the screen structure (hereinafter referred to as “screen structure of the sample”) of the sample screen data and the screen component (hereinafter referred to as “screen component of the processing target”) in the screen structure (hereinafter referred to as “screen structure of the processing target”) of the processing target screen data that have the same attribute value and could be equivalent. For example, in the case where the screen structure is a directed tree, the masking apparatus considers whether those that have the same attribute value and could be equivalent are in the same relationship regarding not only the screen component and its ancestors, but also sibling screen components and screen components that are not in an ancestor-descendant relationship and are at different depths from the root screen component.

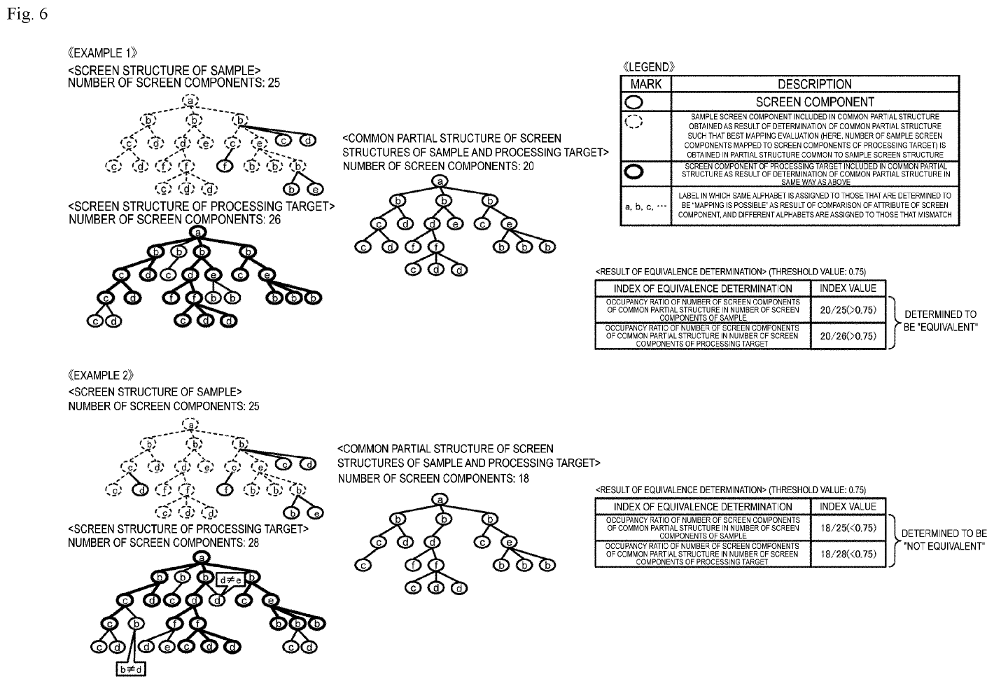

More specifically, as illustrated in FIG. 6, the masking apparatus compares the screen structures of the sample and the processing target, determines the common partial structure such that the best evaluation of the mapping method is obtained based on the number of those mapped to the screen components of the processing target in the all screen components of the sample, and compares, with predetermined threshold values, the occupancy ratio of that number in the number of the sample screen components and the occupancy ratio of that number in the number of the screen components of the processing target to thereby determine the equivalence of the screen and the screen component.

Overview of Operation in Use Case (β)

In the use case (β), the masking apparatus performs, for each screen data in operation logs, identification and comparison with other remaining screen data, and determines all equivalent screen data. Thereafter, the masking apparatus determines whether each screen component in each screen data is the masking target, and performs masking by determining the variation of the display value and the number of equivalent screen components in other equivalent screen data, and comparing them with predetermined threshold values. In addition, in the identification of the screen and the screen component, the masking apparatus uses the same method as that of the “case where masking of only sample screen data is performed”.

Effects of Use Cases

In the use case (α) of the present embodiment, since whether the sample screen component is to be subjected to masking is automatically determined through the comparison and identification of the sample screen data and the processing target screen data acquired in accordance with the operation of the program intended for automation or support of the terminal operation, it is not necessary to manually perform designation, thus reducing the task.

In the use case (β) of the present embodiment, since whether each screen component is to be subjected to masking is automatically determined through the comparison and identification of screen data in operation logs, it is not necessary to manually perform the selection of the screen data set as the sample and the designation of the screen component that requires masking of the display value, and thus the task is reduced.

Note that in either case, in the present embodiment, the variation of the display value of the equivalent screen component in a plurality of equivalent screen data acquired through actual terminal operations and its automatic execution is examined, and thus whether only a limited candidate value can be set or any value can be set can be determined based on the use conditions and/or the behavior of the program that operates in the terminal regardless of the type of the screen component.

In addition, the present embodiment requires the comparison and identification of screen data; however, in practice, it suffices that at least the type of the screen component can be used as the attribute value of the screen component, and thus it is not influenced by the variation of other attribute values. In addition, the variation of the screen structure can be accommodated since the determination is made based on not whether the screen structure completely matches, but by determining the common partial structure with which the best evaluation of the mapping method is obtained and comparing it with a predetermined threshold value.

Even in the case where the invariant attribute is limited to the type of the screen component and the like and each screen component cannot be uniquely identified in the screen even by using the attributes of the screen component and its ancestors or a combination of a plurality of attributes, the present embodiment more widely considers whether one with the same attribute value is in the same relationship also for screen components that are not in an ancestor-descendant relationship, and thus the possibility of identification is increased.

The screen structure is not changed by the size of the screen and/or the volume of the display content of each screen component, and therefore even when the arrangement on a two-dimensional plane is changed, there is no influence in the present embodiment.

In the case where the screen component to be subjected to masking or not to be subjected to masking is designated by using sample screen data selected from the screen data in the use case (β), it is necessary to manually create the condition for determining the equivalence of the screen component in the related-art method, but in the present embodiment, such an operation need not necessarily be performed.

Configuration of Masking Apparatus

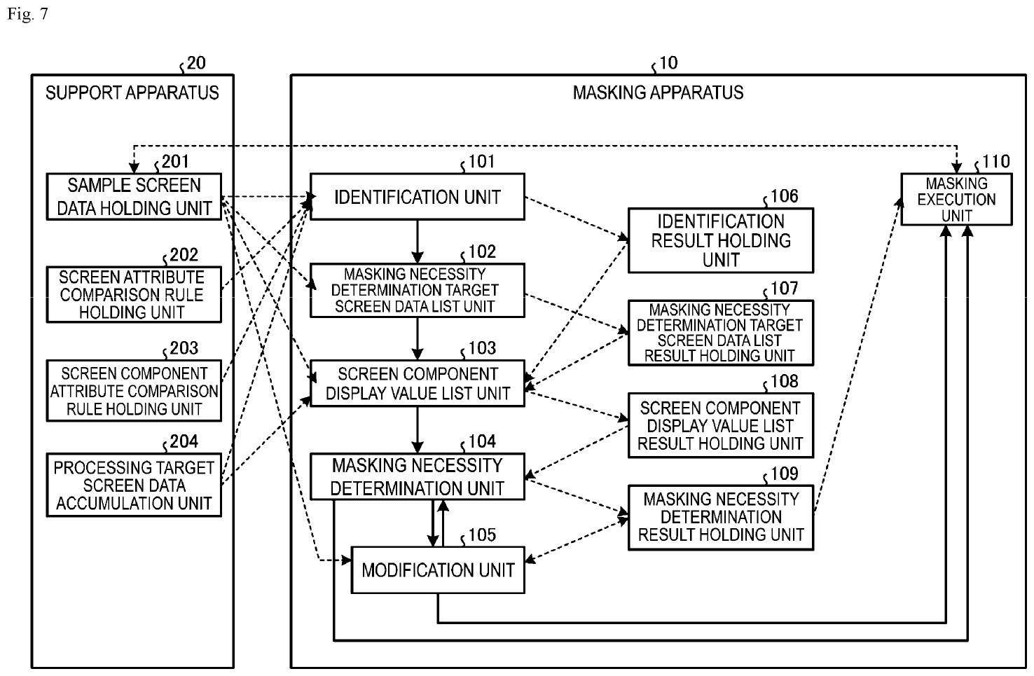

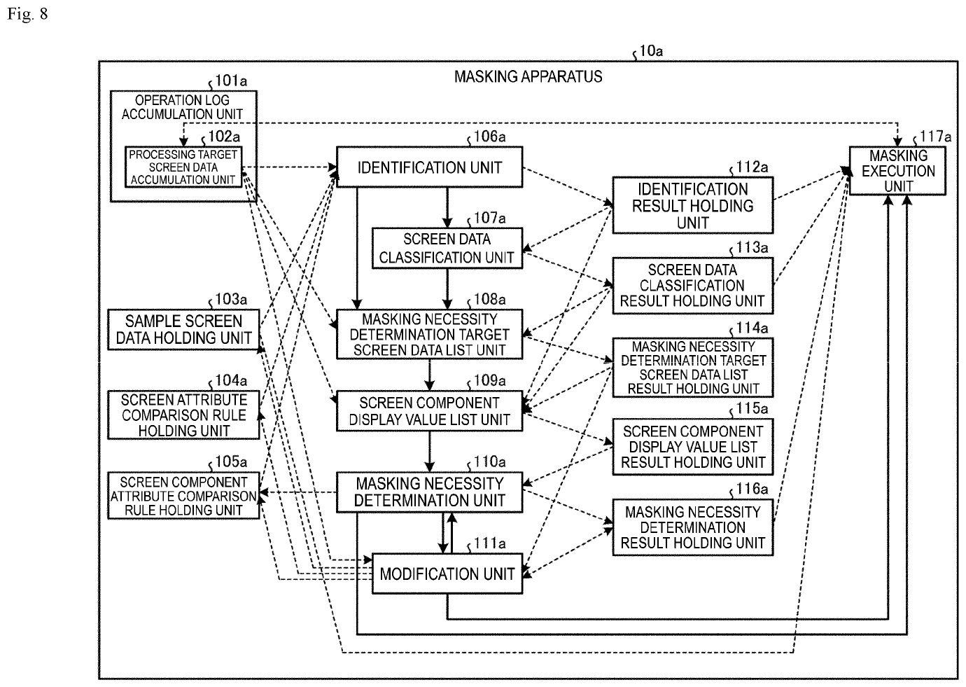

FIG. 7 is a diagram illustrating an exemplary configuration of the masking apparatus (the use case (α)). In addition, FIG. 8 is a diagram illustrating an exemplary configuration of the masking apparatus (the use case (β)). As illustrated in FIG. 7, a masking apparatus 10 is connected to a support apparatus 20 that performs automation and support of a terminal operation. In addition, the masking apparatus 10 may be implemented as a part of a functional part of the support apparatus 20. In addition, a part or all of the functional part of the support apparatus 20 may be provided in the masking apparatus 10. For example, a processing target screen data accumulation unit 204 and a sample screen data holding unit 201 of the support apparatus 20 may be provided in the masking apparatus 10. In addition, for example, a screen attribute comparison rule holding unit 202 and a screen component attribute comparison rule holding unit 203 may be provided in the masking apparatus 10.

As illustrated in FIG. 7, the support apparatus 20 includes the sample screen data holding unit 201, the screen attribute comparison rule holding unit 202, the screen component attribute comparison rule holding unit 203 and the processing target screen data accumulation unit 204.

The masking apparatus 10 includes a configuration for implementing the operation in the use case (α). As illustrated in FIG. 7, the masking apparatus 10 includes an identification unit 101, a masking necessity determination target screen data list unit 102, a screen component display value list unit 103, a masking necessity determination unit 104, a modification unit 105, an identification result holding unit 106, a masking necessity determination target screen data list result holding unit 107, a screen component display value list result holding unit 108, a masking necessity determination result holding unit 109, and a masking execution unit 110.

In addition, a masking apparatus 10a includes a configuration for implementing the operation in the use case (β). As illustrated in FIG. 8, the masking apparatus 10a includes an operation log accumulation unit 101a, a processing target screen data accumulation unit 102a, a sample screen data holding unit 103a, a screen attribute comparison rule holding unit 104a, a screen component attribute comparison rule holding unit 105a, an identification unit 106a, a screen data classification unit 107a, a masking necessity determination target screen data list unit 108a, a screen component display value list unit 109a, a masking necessity determination unit 110a, a modification unit 111a, an identification result holding unit 112a, a screen data classification result holding unit 113a, a masking necessity determination target screen data list result holding unit 114a, a screen component display value list result holding unit 115a, a masking necessity determination result holding unit 116a, and a masking execution unit 117a.

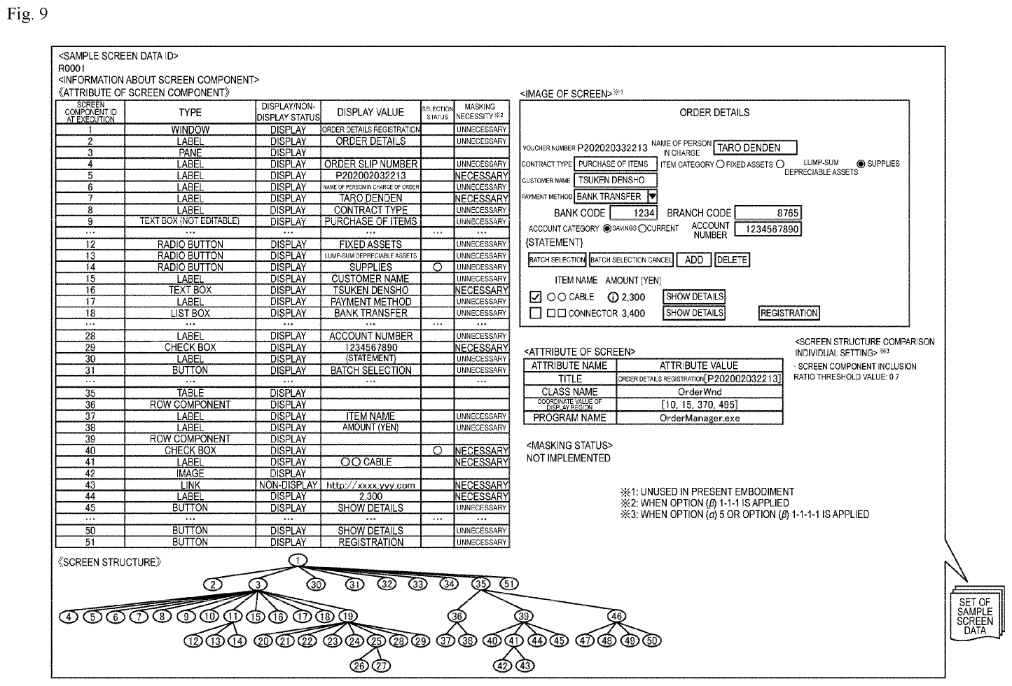

FIG. 9 is a diagram illustrating an example of data held by the sample screen data holding unit. As illustrated in FIG. 9, the sample screen data holding unit 201 and the sample screen data holding unit 103a hold a set of screen data.

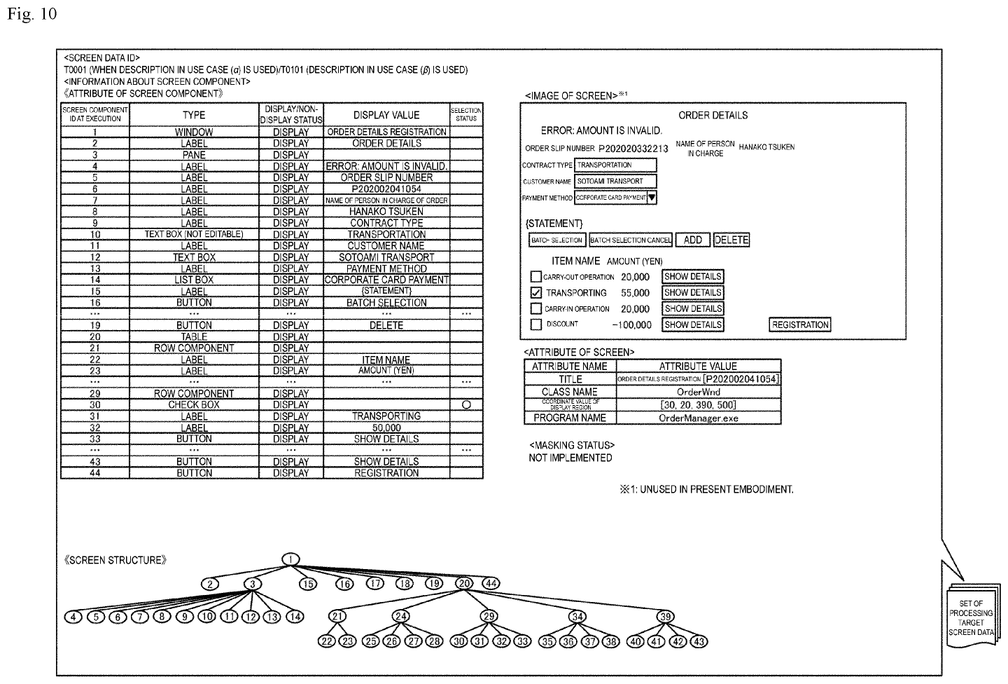

FIG. 10 is a diagram illustrating an example of data held by a processing target screen data accumulation unit. As illustrated in FIG. 10, the processing target screen data accumulation unit 204 and the processing target screen data accumulation unit 102a hold a set of screen data.

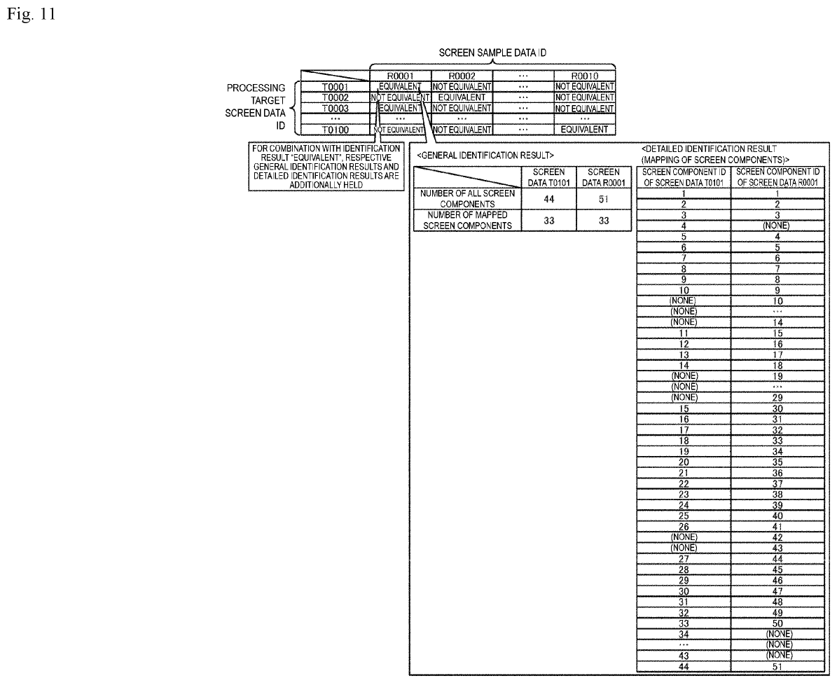

FIG. 11 is a diagram illustrating an example of data held by the identification result holding unit (the use case (α)). As illustrated in FIG. 11, the identification result holding unit 106 holds whether each combination of a processing target screen and a sample screen is “equivalent” or “not equivalent”. In addition, for an “equivalent” combination, the number of mapped screen components and the like are additionally held.

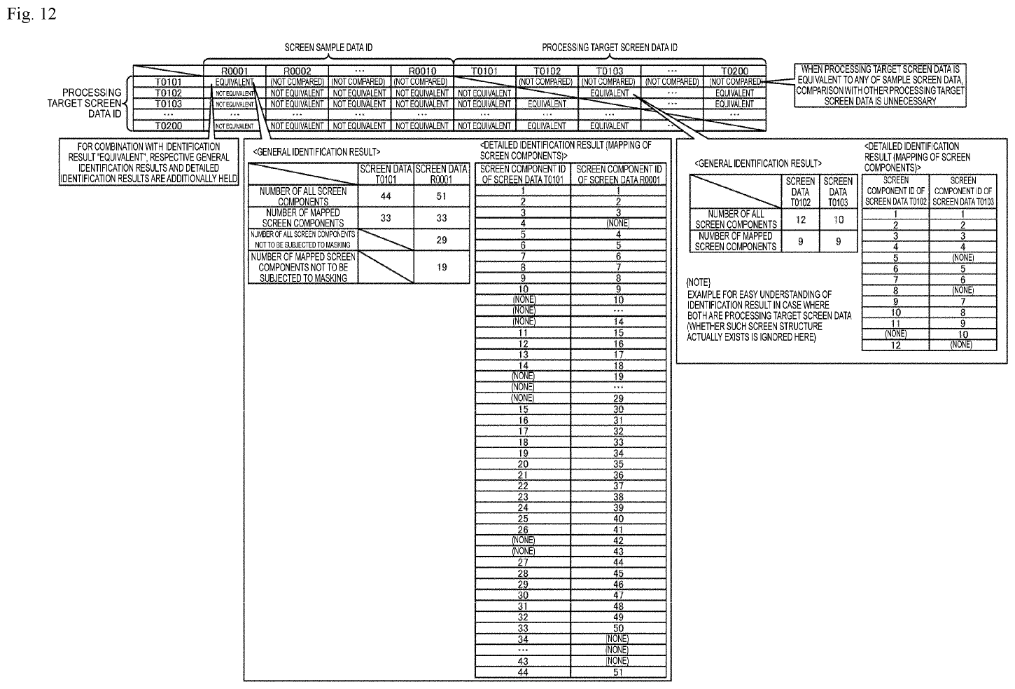

FIG. 12 is a diagram illustrating an example of data held by the identification result holding unit (the use case (β)). As illustrated in FIG. 12, the identification result holding unit 112a holds whether each combination of a processing target screen and a sample screen or other processing target screens is “equivalent” or “not equivalent”. In addition, for an “equivalent” combination, the number of mapped screen components and the like are additionally held.

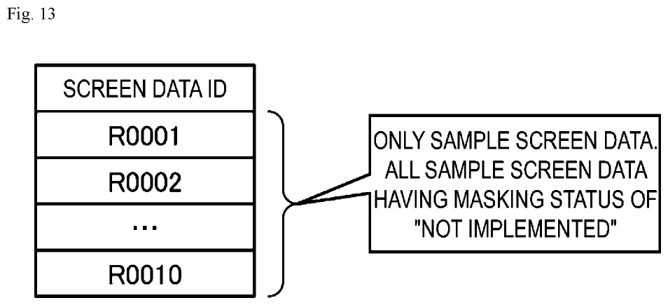

FIG. 13 is a diagram illustrating an example of data held by the masking necessity determination target screen data list result holding unit (the use case (α)). As illustrated in FIG. 13, the masking necessity determination target screen data list result holding unit 107 holds screen data ID of a sample screen having the masking status of “not implemented”.

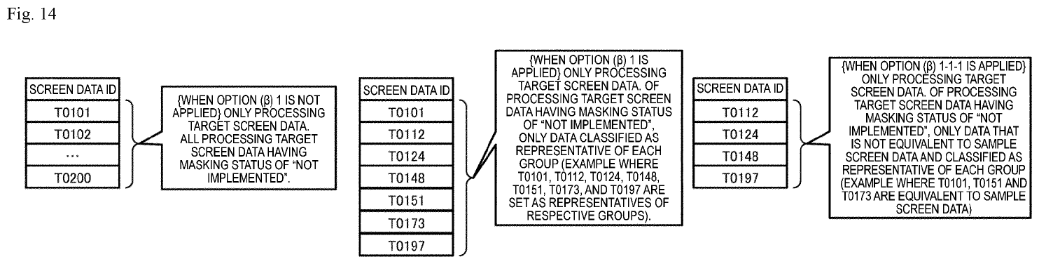

FIG. 14 is a diagram illustrating an example of data held by the masking necessity determination target screen data list result holding unit (the use case (β)). As illustrated in FIG. 14, the masking necessity determination target screen data list result holding unit 107 holds screen data ID in accordance with the application of each option. Here, the options are optionally applicable processes in the processes included in each use case.

An option (α) 1 is an option in which the modification unit 105 is enabled. In addition, an option (α) 2-1 is an option in which the screen attribute comparison rule holding unit 202 is enabled. In addition, an option (α) 3 is an option in which the screen component attribute comparison rule holding unit 203 is enabled.

An option (β) 1 is an option in which the screen data classification unit 107a and the screen data classification result holding unit 113a are enabled. As illustrated in FIG. 14, when the option (β) 1 is not applied, the masking necessity determination target screen data list result holding unit 114a holds screen data ID of the processing target screen having the masking status of “not implemented”. On the other hand, when the option (β) 1 is applied, the masking necessity determination target screen data list result holding unit 114a holds the screen data ID of the screen data that is set as a representative of each group as a result of classification in the processing target screen data having the masking status of “not implemented”.

In addition, when the option (β) 1-1-1 is applied, the masking necessity determination target screen data list result holding unit 114a holds the screen data ID of the screen data that is not equivalent to the sample screen data and is set as a representative of each group as a result of classification in the processing target screen data having the masking status of “not implemented”. Note that the option (β) 1-1-1 is an option in which the sample screen data holding unit 103a is enabled.

Here, the option (β) 1-1 is an option in which the modification unit 111a is enabled. In addition, an option (β) 2-1 is an option in which the screen attribute comparison rule holding unit 104a is enabled. In addition, an option (β) 3 is an option in which the screen component attribute comparison rule holding unit 105a is enabled.

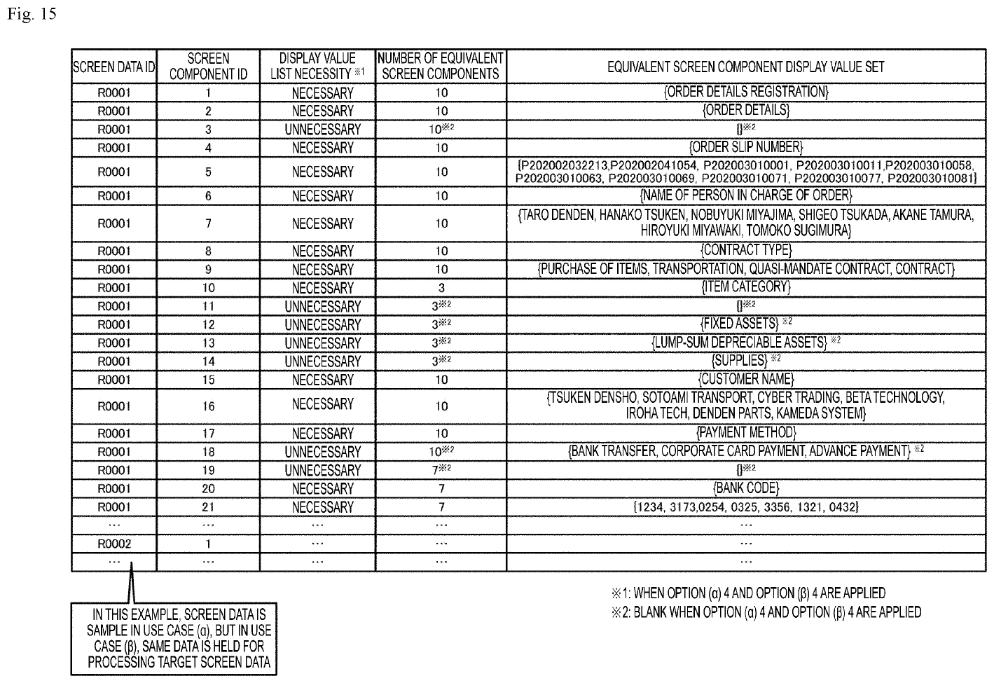

FIG. 15 is a diagram illustrating an example of data held by the screen component display value list result holding unit. As illustrated in FIG. 15, the screen component display value list result holding unit 108 and the screen component display value list result holding unit 115a hold the necessity of listing of the display value, the number of equivalent screen components, and the equivalent screen component display value set for each component of each screen. Note that the screen component display value list result holding unit 108 holds the screen data ID of the sample screen as “screen data ID”. On the other hand, the screen component display value list result holding unit 115a holds the screen data ID of the processing target screen as “screen data ID”.

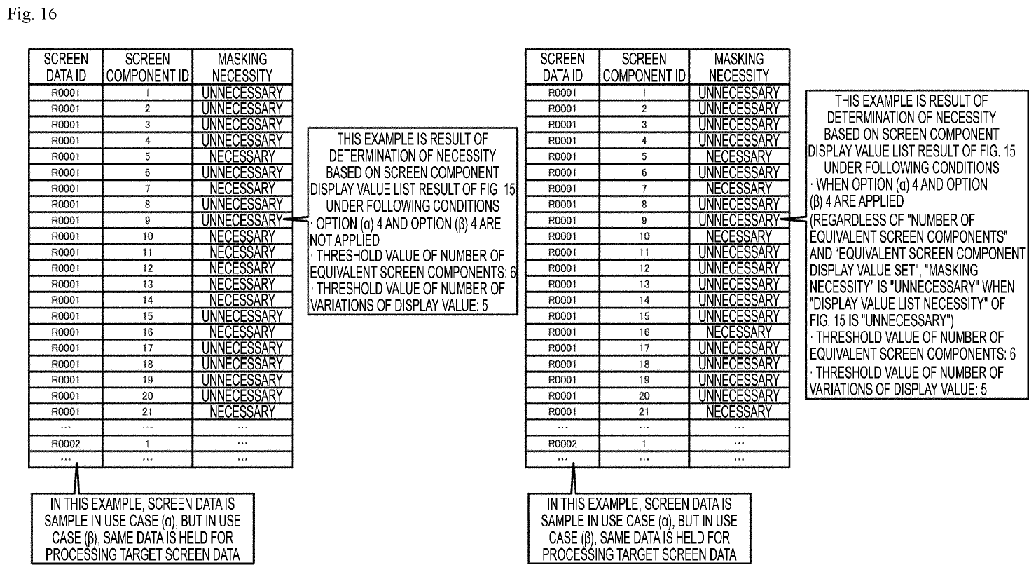

FIG. 16 is a diagram illustrating an example of data held by the masking necessity determination result holding unit. The example of FIG. 16 is a result of the determination of the necessity based on a screen component display value list result under the following conditions.

The threshold value of the number of equivalent screen components: 6
The threshold value of the number of the variations of the display value: 5

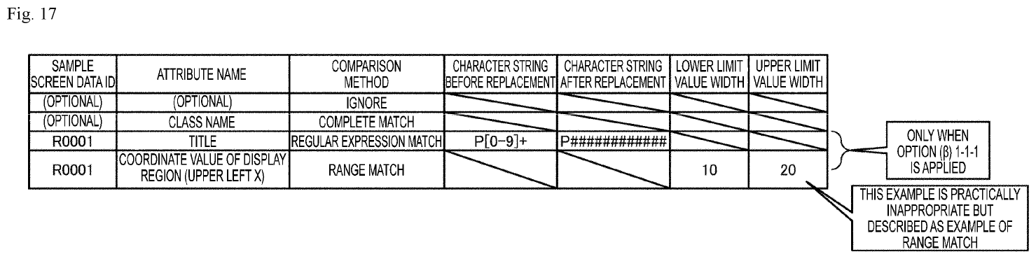

FIG. 17 is a diagram illustrating an example of data held by the screen attribute comparison rule holding unit. As illustrated in FIG. 17, the screen attribute comparison rule holding unit 202 and the screen attribute comparison rule holding unit 104a hold the comparison rule of each attribute of the screen.

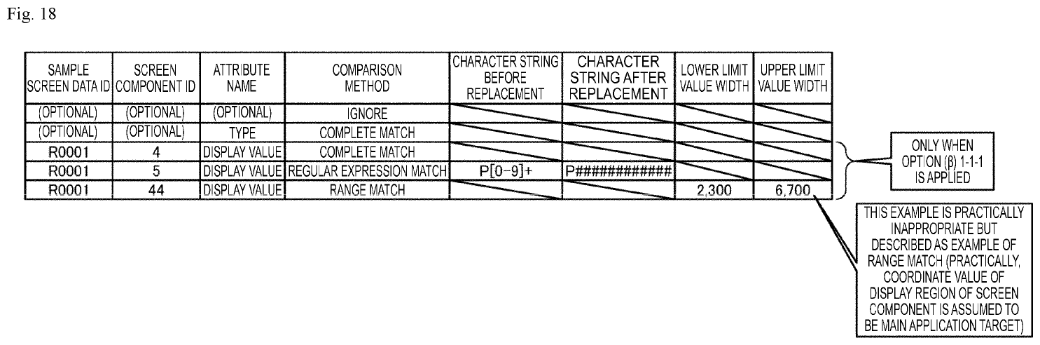

FIG. 18 is a diagram illustrating an example of data held by the screen component attribute comparison rule holding unit. As illustrated in FIG. 18, the screen component attribute comparison rule holding unit 203 and the screen component attribute comparison rule holding unit 105a hold the comparison rule of each attribute of the screen and the screen component.

The operation log accumulation unit 101a accumulates the operation log that is acquired when the terminal operator performs an operation or the like on the terminal screen. Each operation includes at least one piece of screen data. Each operation log may include information for identifying the screen component of the operation target and data representing the operation content such as keyboard input, button clicking, and window state switching, in addition to the screen data. In the present disclosure, only screen data is targeted, and the illustration of the example of the data held by the operation log accumulation unit 101a is omitted since the details thereof are described above for the processing target screen data accumulation unit.

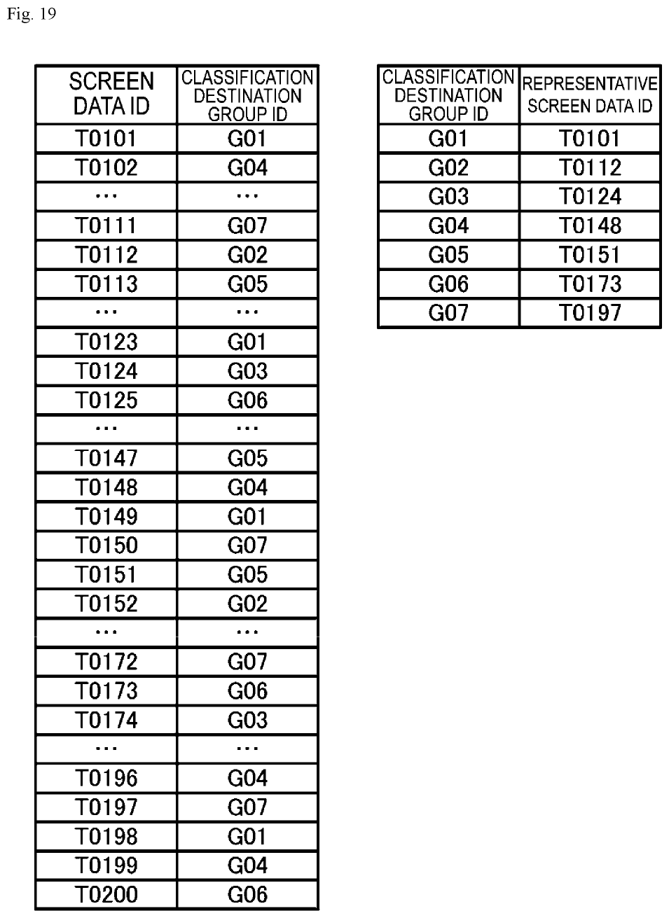

FIG. 19 is a diagram illustrating an example of data held by the screen data classification result holding unit. As illustrated in FIG. 19, the screen data classification result holding unit 113a holds a classification destination group of each screen data, and representative screen data (ID) of each classification destination group.

The identification unit 101 compares the screen data to determine whether they are equivalent, and stores the result in the identification result holding unit 106. In addition, the identification unit 101 calls the masking necessity determination target screen data list unit 102. Likewise, the identification unit 106a compares the screen data to determine whether they are equivalent, and stores the result in the identification result holding unit 112a. In addition, the identification unit 106a calls the masking necessity determination target screen data list unit 108a.

In the use case (α), one piece of the screen data to be compared is the sample screen data held by the sample screen data holding unit. The identification unit 101 may compare the attribute of the screen in the determination of the equivalence of the screen (when the option (α) 2 is applied). Further, the identification unit 101 may use the comparison rule held by the screen attribute comparison rule holding unit 202 (when the option (α) 2-1 is applied). The identification unit 101 may use the comparison rule held by the screen component attribute comparison rule holding unit 203 in the determination whether the mapping of the screen component is possible, which is performed as a part of the determination of the equivalence of the screen (when the option (α) 3 is applied).

In the use case (β), each screen data to be compared is the screen data accumulated in the processing target screen data accumulation unit. The identification unit 106a may compare the attribute of the screen in the determination of the equivalence of the screen (when the option (β) 2 is applied). Further, the identification unit 106a may use the comparison rule held by the screen attribute comparison rule holding unit 104a (when the option (β) 2-1 is applied).

The identification unit 106a may use the comparison rule held by the screen component attribute comparison rule holding unit 105a in the determination whether the mapping of the screen component is possible, which is performed as a part of the determination of the equivalence of the screen (when the option (β) 3 is applied).

The identification unit 106a may call the screen data classification unit 107a instead of calling the masking necessity determination target screen data list unit 108a (when the option (β) 1 is applied). In the case where there is the sample screen data in the sample screen data holding unit 103a, the identification unit 106a may set one piece of the screen data to be compared as the sample screen data held by the sample screen data holding unit (when the option (β) 1-1-1 is applied).

In the subsequent processes in the screen component display value list unit 103 and the masking necessity determination unit 104, the masking necessity determination target screen data list unit 102 lists the screen data to be subjected to the masking necessity determination as follows, and stores the result in the masking necessity determination target screen data list result holding unit 107. The masking necessity determination target screen data list unit 102 calls the screen component display value list unit 103.

Likewise, in the subsequent processes in the screen component display value list unit 109a and the masking necessity determination unit 110a, the masking necessity determination target screen data list unit 108a lists the screen data to be subjected to the masking necessity determination as follows, and stores the result in the masking necessity determination target screen data list result holding unit 114a. The masking necessity determination target screen data list unit 108a calls the screen component display value list unit 109a.

In the use case (α), the screen data to be subjected to the masking necessity determination is the sample screen data having the masking status of “not implemented” and held by the sample screen data holding unit.

In the use case (β), the screen data to be subjected to the masking necessity determination is the screen data having the masking status of “not implemented” and held by the processing target screen data accumulation unit. In addition, in the case where there is a classification result in the screen data classification result holding unit, the masking necessity determination target screen data list unit 108a sets only the representative of each group in the result of the classification (when the option (β) 1 is applied) as the screen data to be subjected to the masking necessity determination. Further, the masking necessity determination target screen data list unit 108a excludes, from the masking necessity determination target, the screen data that is determined by the identification unit 106a to be equivalent to any of the sample screen data (when the option (β) 1-1-1 is applied).

For each screen data to be subjected to the masking necessity determination, the screen component display value list unit 103 acquires all screen data determined to be equivalent, on the basis of the identification result of the screen component held by the identification result holding unit 106. For each screen component in each screen data to be subjected to the masking necessity determination, the screen component display value list unit 103 determines the variation of the display value and the number of equivalent screen components in other equivalent screen data, and stores the result in the screen component display value list result holding unit 108. In addition, the screen component display value list unit 103 calls the masking necessity determination unit 104.

For each screen data to be subjected to the masking necessity determination, the screen component display value list unit 109a acquires all screen data determined to be equivalent on the basis of the identification result of the screen component held by the identification result holding unit 112a. For each screen component in each screen data to be subjected to the masking necessity determination, the screen component display value list unit 109a determines the variation of the display value and the number of equivalent screen components in other equivalent screen data, and stores the result in the screen component display value list result holding unit 115a. In addition, the screen component display value list unit 109a calls the masking necessity determination unit 110a.

Note that for screen components, such as a list box, for which it is clear from the type of the screen component that the display value obviously can only have a limited candidate value, the process of determining the number of equivalent screen components and the variation of the display value may be omitted (when an option (α) 4 or an option (β) 4 is applied).

For each screen component of each screen data to be subjected to the masking necessity determination, the masking necessity determination unit 104 compares the list result held in the screen component display value list result holding unit 108 with a predetermined threshold value to thereby determine whether each screen component is to be subjected to masking, and stores the result in the masking necessity determination result holding unit 109. In addition, the masking necessity determination unit 104 calls the masking execution unit 110.

Note that the masking necessity determination unit 104 may call the modification unit 105 instead of calling the masking execution unit 110 (when the option (α) 1 is applied). In addition, for screen components, such as a list box, for which it is clear from the type of the screen component that the display value obviously can only have a limited candidate value, it is possible to determine that the list result is not to be subjected to masking, without comparing it with a predetermined threshold value (when the option (α) 4 is applied).

For each screen component of each screen data to be subjected to the masking necessity determination, the masking necessity determination unit 110a compares the list result held in the screen component display value list result holding unit 115a with a predetermined threshold value to thereby determine whether each screen component is to be subjected to masking, and stores the result in the masking necessity determination result holding unit 116a. In addition, the masking necessity determination unit 110a calls the masking execution unit 117a.

Note that the masking necessity determination unit 110a may call the modification unit 111a instead of calling the masking execution unit 117a (when the option (β) 1 is applied). In addition, for screen components, such as a list box, for which it is clear from the type of the screen component that the display value obviously can only have a limited candidate value, it is possible to determine that the list result is not to be subjected to masking, without comparing it with a predetermined threshold value (when the option (β) 4 is applied).

For each screen component of each screen data to be subjected to masking, the masking execution unit 110 masks its display value when the masking is “necessary” on the basis of the determination result held by the masking necessity determination result holding unit 109.

For each screen component of each screen data to be subjected to masking, the masking execution unit 117a masks its display value when the masking is “necessary” on the basis of the determination result held by the masking necessity determination result holding unit 116a.

The result of the masking is reflected in the sample screen data holding unit 201 in the use case (α) and in the processing target screen data accumulation unit 102a in the use case (β), and the masking status is changed to “implemented”.

In the use case (α), the screen data to be subjected to masking is the sample screen data having the masking status of “not implemented” and held by the sample screen data holding unit 201. In the use case (β), the screen data to be subjected to masking is the screen data having the masking status of “not implemented” and held by the processing target screen data accumulation unit 102a.

When there is no masking necessity determination result of the screen data itself to be subjected to masking in the masking necessity determination result holding unit 116a, the masking execution unit 117a uses the masking necessity determination result of the representative screen data of the same group. Specifically, for the screen data to be subjected to masking, the masking execution unit 117a specifies the representative screen data of the same group on the basis of the classification result held by the screen data classification result holding unit 113a.

Thereafter, for each screen component in the screen data to be subjected to masking, the masking execution unit 117a specifies the equivalent screen component in the representative screen data of the same group on the basis of the identification result of the screen and screen component held by the identification result holding unit 112a. When it cannot be specified, the masking execution unit 117a masks its display value. When it can be specified, the masking execution unit 117a examines the masking necessity determination result of the representative screen data in the determination result held by the masking necessity determination result holding unit 116a, and masks its display value when the masking of the equivalent screen component is “necessary” (when the option (β) 1 is applied).

Further, when the identification unit 106a determines that the screen data to be subjected to masking is equivalent to any of the sample screen data, the masking execution unit 117a specifies, for each screen component, the equivalent screen component of the sample on the basis of the identification result held by the identification result holding unit 112a. When it cannot be specified, the masking execution unit 117a masks its display value. When it can be specified, the masking execution unit 117a examines whether the equivalent screen component of the sample is not to be subjected to masking on the basis of the sample screen data, and masks its display value when it is not examined that the equivalent screen component is not to be subjected to masking (when the option (β) 1-1-1 is applied).

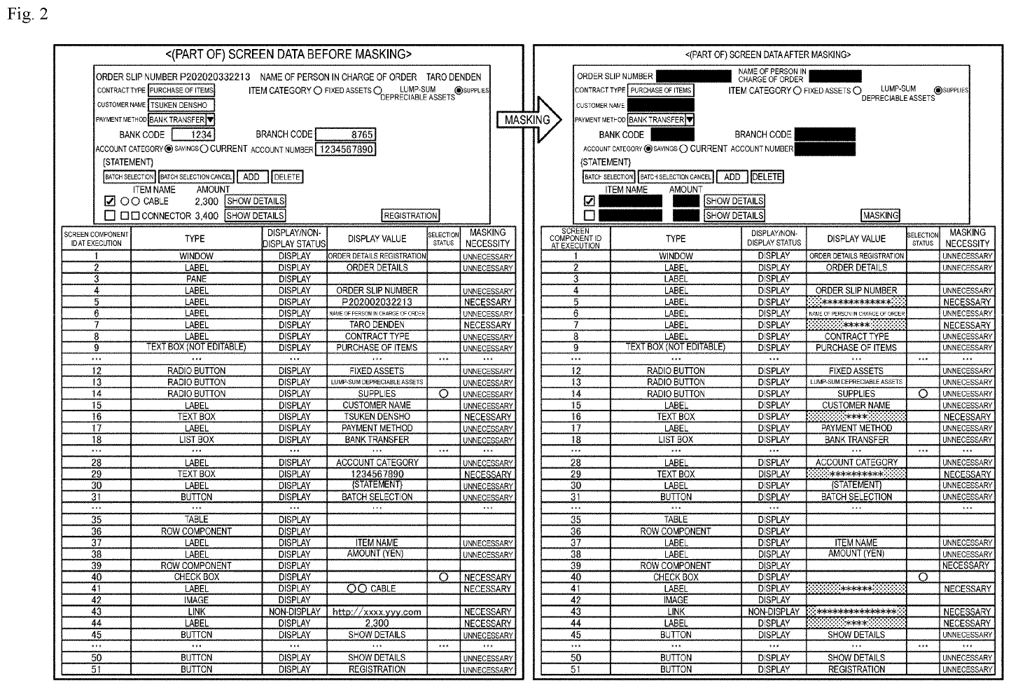

The modification unit 105 displays the determination result held by the masking necessity determination result holding unit 109, in a form easily understandable to people. Likewise, the modification unit 111a displays the determination result held by the masking necessity determination result holding unit 116a, in a form easily understandable to people can easily understand. For the display form, it is conceivable to use a method in which the image of each screen data to be subjected to the masking necessity determination is displayed, and then the region of the screen component to be subjected to masking is covered with a rectangle as illustrated in FIG. 2, for example.

Note that each screen data to be subjected to the masking necessity determination is acquired from the sample screen data holding unit 201 in the use case (α), and is acquired from the processing target screen data accumulation unit 102a in the use case (β). In addition, it is possible to change the threshold value used for the determination at the masking necessity determination unit through a manual operation, perform the masking necessity determination again by calling the masking necessity determination unit 104 or the masking necessity determination unit 110a, and display the determination result after the change again. Alternatively, it is possible to individually change the screen component masking necessity through a manual operation, and reflect the result of the change in the masking necessity determination result holding unit 109 and the masking necessity determination result holding unit 116a.

Further, in the use case (β), the masking necessity determination unit 110a may store each screen data to be subjected to the masking necessity determination and the masking necessity determination result for its screen data in the sample screen data holding unit 103a (when the option (β) 1-1-1 is applied).

The screen comparison rule may be manually designated. The details of the designation are stored in the screen attribute comparison rule holding unit 104a (when the option (β) 2-1 is applied). In addition, the screen component attribute comparison rule may be manually designated. The details of the designation are stored in the attribute value of the screen component comparison rule holding unit (when the option (β) 3 is applied). In addition, the screen structure comparison individual setting may be manually designated. The details of the designation are reflected in the screen data held by the sample screen data holding unit 103a (when the option (β) 1-1-1-1 is applied).

On the basis of the identification result held by the identification result holding unit 112a, the screen data classification unit 107a classifies the screen data into groups such that the equivalent screen data is classified in the same group and such that the number of groups becomes as small as possible. In addition, the screen data classification unit 107a selects one piece of representative screen data for each group. Further, the screen data classification unit 107a calls the masking necessity determination target screen data list unit 108a. The screen data classification unit 107a excludes, from the classification target, the screen data that is determined by the identification unit 106a to be equivalent to any of the sample screen data (when the option (β) 1-1-1 is applied).

As described above, the processing units of the masking apparatus have the following characteristics. The identification unit identifies the screen and the screen components included in each of first screen data serving as a reference, and one or more pieces of second screen data serving as a processing target. The identification unit 101 and the identification unit 106a correspond to the identification unit. For example, the sample screen data may correspond to the first screen data, and the processing target screen data may correspond to the second screen data. In addition, for example, the screen data of the processing target may correspond to both the first screen data and the second screen data.

The specifying unit specifies third screen data equivalent to the first screen data in the second screen data on the basis of the identified screen and screen component. The screen component display value list unit 103 and the screen component display value list unit 109a correspond to the specifying unit.

The determination unit determines the necessity of masking of each screen component included in the first screen data on the basis of the third screen data. For example, the determination unit determines the necessity of masking of each screen component included in the first screen data on the basis of the number of screen components included in the first screen data equivalent to the screen component included in the third screen data, and the number of variations of the display value of the screen component included in the first screen data on the basis of the display value of the screen component included in the third screen data. The masking necessity determination unit 104 and the masking necessity determination unit 110a correspond to the determination unit.

In addition, the identification unit identifies the screen and the screen components included in each of the first screen data prepared as a sample and one or more pieces of second screen data serving as a processing target. In addition, for each of the first screen data included in the operation log and the second screen data that is screen data included in the operation log and is different from the first screen data, the identification unit identifies the screen and the screen components. In this manner, the present embodiment supports both the use case (α) and the use case (β).

The screen data classification unit 107a classifies the screen data included in the operation log into a plurality of groups, and selects representative screen data for each group. At this time, the specifying unit and the determination unit can perform the process by using the classification result. In addition, the screen component display value list unit 109a corresponds to the specifying unit. In this manner, for each screen component of the screen data other than the representative, the processing up to the masking can be performed without examining the equivalent screen component in other screen data included in the same group, and thus the computational quantity is reduced.

When the third screen data is screen data whose determination result of the necessity of masking is already stored, the determination unit determines the necessity of masking of each screen component included in the first screen data on the basis of the stored determination result. In this manner, the determination of the masking necessity can be omitted by reusing the existing determination result of the masking necessity.

The masking execution unit 117a executes the masking for the screen component determined to require the masking by the determination unit. In this manner, the masking apparatus can automatically perform the entire process from the specifying of the masking target to the masking.

A flowchart of each process will be described below. In the following description, the subject of the processes is the masking apparatus. In practice, the process related to the use case (α) is executed by the masking apparatus 10, and the process related to the use case (β) is executed by the masking apparatus 10a. In addition, the processes without designating the use case and the option may be commonly executed by both the masking apparatus 10 and the masking apparatus 10a. In addition, the reference numerals of other processing unit are also appropriately omitted. Note that the identification result holding unit correspond to the identification result holding unit 106 or the identification result holding unit 112a.

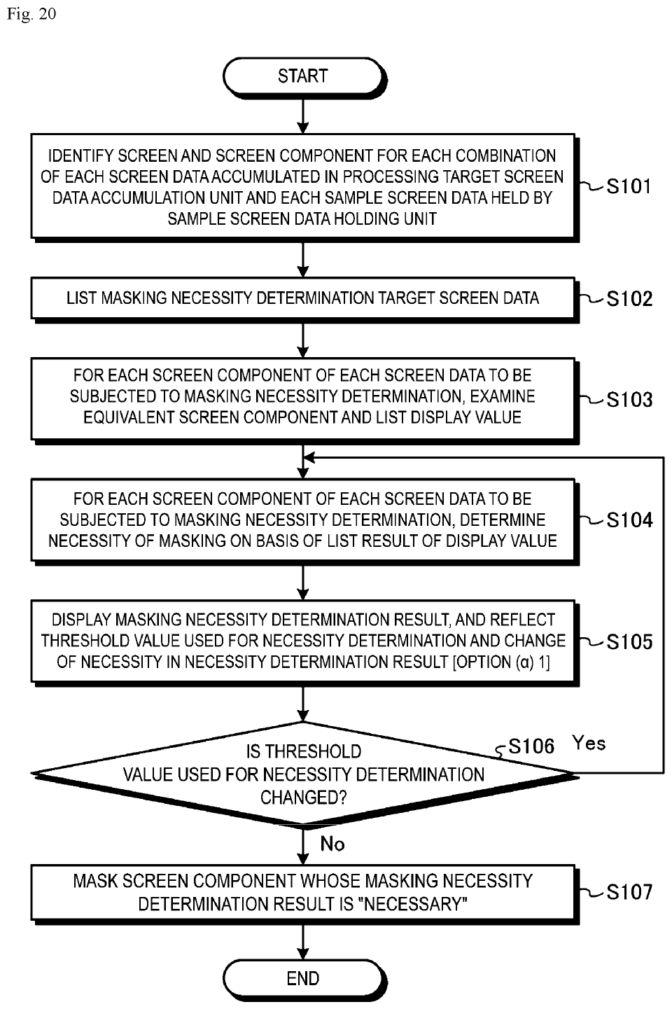

FIG. 20 is a flowchart of an entire masking process (the use case (α)). As illustrated in FIG. 20, the masking apparatus identifies the screen and the screen component for each combination of each screen data accumulated in the processing target screen data accumulation unit and each sample screen data held by the sample screen data holding unit (step S101). The masking apparatus lists the masking necessity determination target screen data (step S102).

For each screen component of each screen data to be subjected to the masking necessity determination, the masking apparatus examines the equivalent screen component and lists the display value (step S103). For each screen component of each screen data to be subjected to the masking necessity determination, the masking apparatus determines the necessity of the masking on the basis of the list result of the display value (step S104). The masking apparatus displays the masking necessity determination result, and reflects the threshold value used for the necessity determination and the change of the necessity in the necessity determination result [the option (α) 1] (step S105).

When the threshold value used for the necessity determination is changed (step S106, Yes), the masking apparatus returns the process to step S104. When the threshold value used for the necessity determination is not changed (step S106, No), the masking apparatus proceeds to step S107. The masking apparatus masks the screen component whose masking necessity determination result is “necessary” (step S107).

At step S105, after the necessity of the masking is automatically determined for each screen component in each sample screen data held by the sample screen data holding unit through comparison with the screen data accumulated in the processing target screen data accumulation unit, and before the masking is actually performed, it may be manually checked such that the necessity of the masking may be changed (when the option (α) 1 is applied).

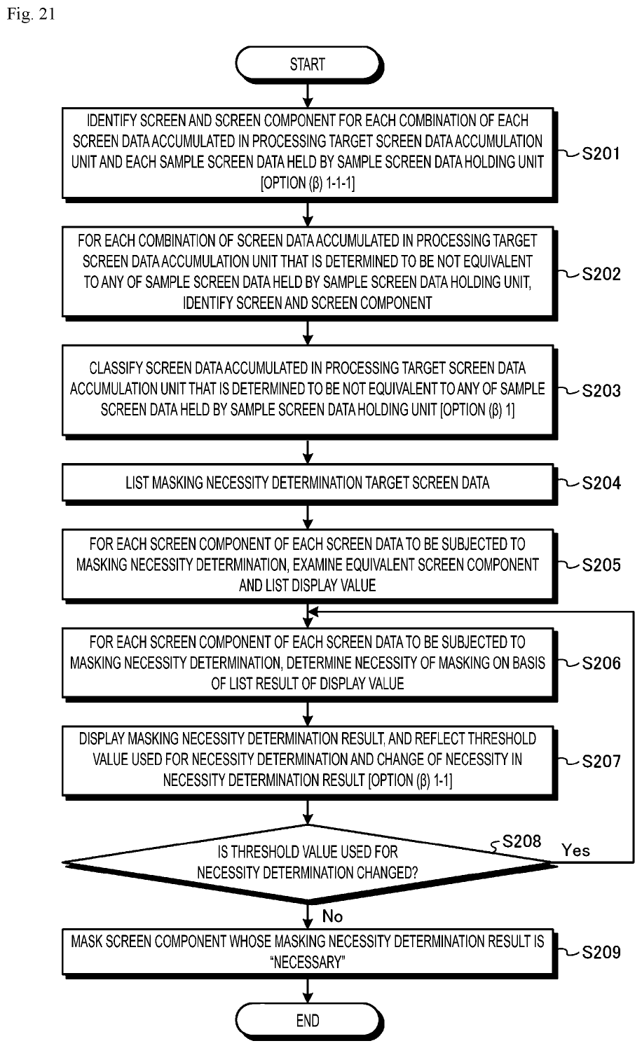

FIG. 21 is a flowchart of an entire masking process (the use case (β)). As illustrated in FIG. 21, the masking apparatus identifies the screen and the screen component for each combination of each screen data accumulated in the processing target screen data accumulation unit and each sample screen data held by the sample screen data holding unit [the option (β) 1-1-1] (step S201).

For each combination of the screen data accumulated in the processing target screen data accumulation unit that is determined to be not equivalent to any of the sample screen data held by the sample screen data holding unit, the masking apparatus identifies the screen and the screen component (step S202).

The masking apparatus classifies the screen data accumulated in the processing target screen data accumulation unit that is determined to be not equivalent to any of the sample screen data held by the sample screen data holding unit [the option (β) 1] (step S203).

The masking apparatus lists the masking necessity determination target screen data (step S204). For each screen component of each screen data to be subjected to the masking necessity determination, the masking apparatus examines the equivalent screen component and lists the display value (step S205). For each screen component of each screen data to be subjected to the masking necessity determination, the masking apparatus determines the necessity of the masking on the basis of the list result of the display value (step S206).

The masking apparatus displays the masking necessity determination result, and reflects the threshold value used for the necessity determination and the change of the necessity in the necessity determination result [the option (β) 1-1] (step S207).

When the threshold value used for the necessity determination is changed (step S208, Yes), the masking apparatus returns the process to step S206. When the threshold value used for the necessity determination is not changed (step S208, No), the masking apparatus proceeds to step S209. The masking apparatus masks the screen component whose masking necessity determination result is “necessary” (step S209).

At step S203, the computational quantity required for determining the necessity of masking may be reduced in such a manner that, after the equivalence of the screens is determined through comparison of the screen data accumulated in the processing target screen data accumulation unit and the equivalent screen component is mapped, the screen data is classified and representative screen data of each group is selected to thereby limit the screen data to be subjected to the masking necessity determination to the representative screen data, and examine the variation of the display value of the screen component (when the option (β) 1 is applied).

In addition, at step S207, after the necessity of the masking of each screen component in the screen data is automatically determined, and before the masking is actually performed, the masking necessity may be manually confirmed and changed by using the representative screen data of each group (when the option (β) 1-1 is applied).

Further, at step S201, in the case where the masking is repeatedly performed, such as the case where operation logs are continuously collected and operation logs newly collected until that time point are masked, the task of manual confirmation and change of the masking necessity and the computational quantity required for the process can be reduced by reusing the representative screen data of each group and its masking necessity determination result obtained in the past masking. In view of this, the representative screen data of each group may be registered as sample screen data together with its masking necessity determination result (when the option (β) 1-1-1 is applied). In this case, when a newly collected operation log is masked, whether equivalent one is present in the registered sample screen data is examined first. When equivalent one is present, the display value is masked in accordance with whether the sample screen component equivalent to each screen component is not to be subjected to masking. When equivalent one is not present, the display value is masked after the classification, the masking necessity determination and the like are performed together with the other screen data whose equivalent sample screen data is not present, as in the first masking.

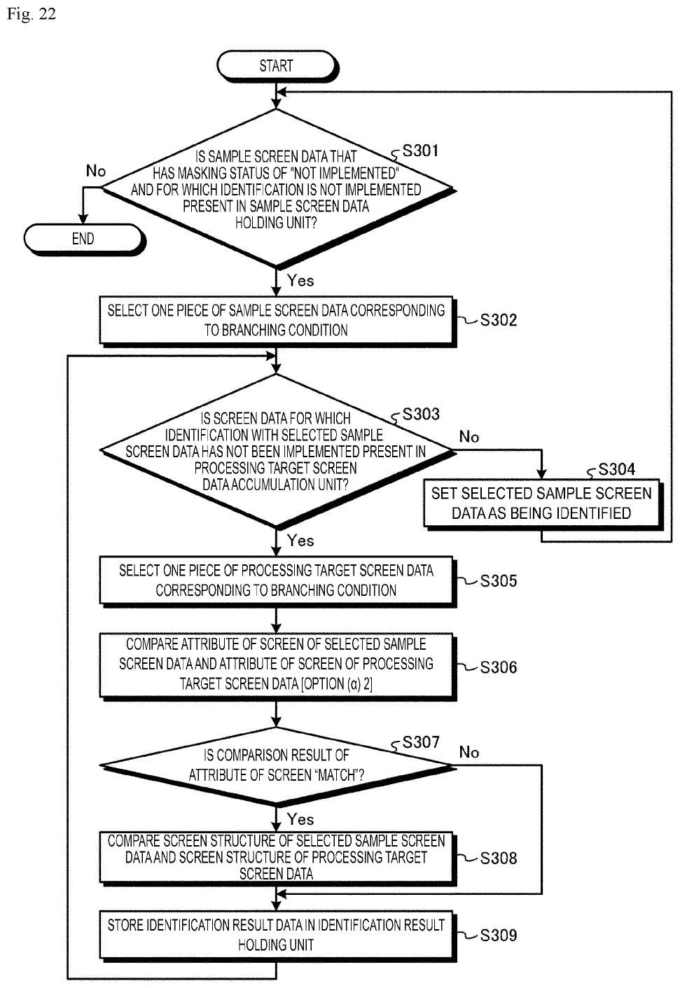

FIG. 22 is a flowchart of an entire process of identifying a screen and a screen component (the use case (α)). When sample screen data that has the masking status of “not implemented” and for which the identification is not implemented is present in the sample screen data holding unit (step S301, Yes), the masking apparatus proceeds to step S302. When the sample screen data is not present (step S301, No), the masking apparatus terminates the process.

The masking apparatus selects one piece of sample screen data corresponding to the branching condition (step S302). When screen data for which the identification with the selected sample screen data has not been implemented is present in the processing target screen data accumulation unit (step S303, Yes), the masking apparatus proceeds to step S305. When the screen data is not present, the masking apparatus proceeds to step S304.

The masking apparatus sets the selected sample screen data as identified data (step S304), and returns to step S301.

The masking apparatus selects one piece of processing target screen data corresponding to the branching condition (step S305). The masking apparatus compares the attribute of the screen of the selected sample screen data and the attribute of the screen of the processing target screen data [the option (α) 2] (step S306).

When the comparison result of the attribute of the screen is “match” (step S307, Yes), the masking apparatus proceeds to step S308. When the comparison result of the attribute of the screen is not “match” (step S307, No), the masking apparatus proceeds to step S309.

The masking apparatus compares the screen structure of the selected sample screen data and the screen structure of the processing target screen data (step S308). The masking apparatus stores the identification result data in the identification result holding unit (step S309), and returns to step S303.

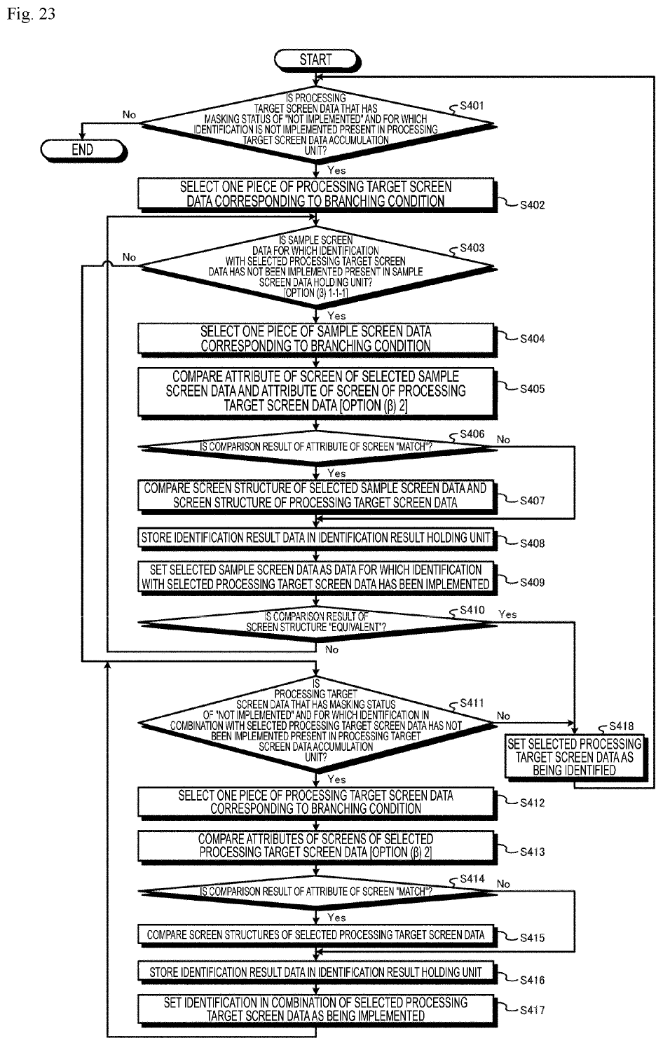

FIG. 23 is a flowchart of an entire process of identifying a screen and a screen component (the use case (β)). As illustrated in FIG. 23, when processing target screen data that has the masking status of “not implemented” and for which the identification is not implemented is present in the processing target screen data accumulation unit (step S401, Yes), the masking apparatus proceeds to step S401. When the processing target screen data is not present (step S401, No), the masking apparatus terminates the process.

The masking apparatus selects one piece of processing target screen data corresponding to the branching condition (step S402). When sample screen data for which the identification with the selected processing target screen data has not been implemented is present in the sample screen data holding unit [the option (β) 1-1-1] (step S403, Yes), the masking apparatus proceeds to step S404. When the sample screen data is not present (step S403, No), the masking apparatus proceeds to step S411.

The masking apparatus selects one piece of sample screen data corresponding to the branching condition (step S404). The masking apparatus compares the attribute of the screen of the selected sample screen data and the attribute of the screen of the processing target screen data [the option (β) 2] (step S405).

When the comparison result of the attribute of the screen is “match” (step S406, Yes), the masking apparatus proceeds to step S407. When the comparison result of the attribute of the screen is not “match” (step S406, No), the masking apparatus proceeds to step S408.

The masking apparatus compares the screen structure of the selected sample screen data and the screen structure of the processing target screen data (step S407). The masking apparatus stores the identification result data in the identification result holding unit (step S408). The masking apparatus sets the selected sample screen data as data whose identification with the selected processing target screen data has been implemented (step S409).

When the comparison result of the screen structure is “equivalent”, the masking apparatus proceeds to step S418. When the comparison result of the screen structure is not “equivalent”, the masking apparatus returns the process to step S403.

When processing target screen data that has the masking status of “not implemented”, and for which the identification in combination with the selected processing target screen data has not been implemented is present in the processing target screen data accumulation unit (step S411, Yes), the masking apparatus proceeds to step S412. When the processing target screen data is not present (step S411, No), the masking apparatus proceeds to step S418. The masking apparatus sets the selected processing target screen data as identified data (step S418), and returns to step S401.

The masking apparatus selects one piece of processing target screen data corresponding to the branching condition (step S412). The masking apparatus compares the attributes of the screens of the selected processing target screen data [the option (β) 2] (step S413). When the comparison result of the attribute of the screen is “match”, the masking apparatus proceeds to step S415. When the comparison result of the attribute of the screen is not “match”, the masking apparatus proceeds to step S416.

The masking apparatus compares the screen structures of the selected processing target screen data (step S415). The masking apparatus stores the identification result data in the identification result holding unit (step S416). The masking apparatus sets the identification of the combination of the selected processing target screen data as being identified (step S417), and returns to step S411.

A supplementary description regarding FIGS. 22 and 23 will be made below. The identification process is performed on two pieces of screen data. More specifically, in the use case (α), the identification process is performed on all combinations of each screen data accumulated in the processing target screen data accumulation unit, and each sample screen data having the masking status of “not implemented” and held by the sample screen data holding unit.

When the option (β) 1-1-1 of the use case (β) is applied, the identification process is performed on all combinations of each screen data having the masking status of “not implemented” and accumulated in the processing target screen data accumulation unit, and each sample screen data m held by the sample screen data holding unit.

In the case where the screen data is determined to be not equivalent to any of the sample screen data, including the case where the option (β) 1-1-1 of the use case (β) is not applied, the identification process is performed on all combinations of each screen data having the masking status of “not implemented” and accumulated in the processing target screen data accumulation unit, and the other screen data accumulated in the processing target screen data accumulation unit and having the masking status of “not implemented”.

In the following description, the former screen data is referred to as “processing target screen data n”, and the latter screen data is referred to as “sample screen data m”. Note that in the use case (α), or in the case where the sample screen data m is not held in the sample screen data holding unit in the use case (β), the sample screen data m does not have screen comparison rules, screen structure comparison individual settings, or screen component comparison rules specific to that screen data.

When the attribute of the screen is compared (when the option (α) 2 or the option (β) 2 is applied), match or mismatch is determined by any of the following methods ((2) is used when the option (α) 2-1 or the option (β) 2-1 is applied).

(1) The attribute is determined to be “match” when the attribute representing the class name matches in the attributes of the screen. Otherwise, the attribute is determined to be “mismatch”.
(2) For each attribute in the screen, the comparison rule to be applied is determined from among the comparison rules held in the screen attribute comparison rule holding unit. The values of the attribute of the processing target screen and the attribute of the sample screen are compared with each other, and match or mismatch is determined as in Table 1 based on the determined comparison rule. When all attributes are determined to be “match”, the attribute of the screen is determined to be “match”. Otherwise, the attribute is determined to be “mismatch”.

TABLE 1
Comparison
method

| | |
|---|---|
| Complete match | When attribute values completely match between a sample and a |
| | processing target, they are determined to match, and mismatch |
| | otherwise. |
| Regular | For each attribute value of a sample and a processing target, replace a |
| expression match | portion that matches a regular expression designated by a character |
| | string before replacement with that designated by a character string after |
| | replacement. |
| | Thereafter, when values after replacement are compared and completely |
| | match, they are determined to match, and mismatch otherwise. |
| Range match | An attribute value of a processing target is equal to or greater than a |
| | value obtained by subtracting a lower limit value width from a attribute |
| | value of a sample and is equal to or smaller than a value obtained by |
| | adding an upper limit value width from a sample attribute value, they |
| | are determined to match, and mismatch otherwise. |
| Ignore | Regardless of attribute values of a sample and a processing target, they |
| | are determined to match. |

Note that the comparison rule to be applied is determined in the following priority order, for example.

Priority 1: a comparison rule in which neither “sample screen data ID” nor “attribute name” is “(optional)”, and there is a match with the attribute name and the ID of the sample screen data m of the comparison target (when the option (β) 1-1-1 is applied in the case of the use case (β)).
Priority 2: a comparison rule in which “sample screen data ID” is not “(optional)”, and there is a match with the ID of the sample screen data m of the comparison target (when the option (β) 1-1-1 is applied in the case of the use case (β)).
Priority 3: a comparison rule in which “attribute name” is not “(optional)”, and there is a match with the attribute name of the comparison target.
Priority 4: a comparison rule other than the priorities 1 to 3, in which there is a corresponding attribute name and ID of the sample screen data m of the comparison target.

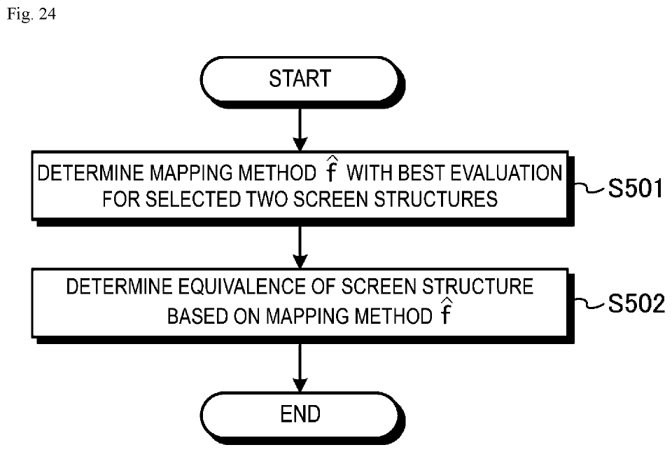

FIG. 24 is a flowchart of a process of comparing a screen structure. As illustrated in FIG. 24, the masking apparatus determines a mapping method \hat{ }f (f with \hat{ } on its top) with the best evaluation for selected two screen structures (step S501). Then, the masking apparatus determines the equivalence of the screen structure on the basis of the mapping method (step S502).

The screen structure is expressed as a graph structure or a tree structure with each screen component as the vertex, and the direct relationship between partial screen components as the side. In the following description, a set of vertices in the screen structure of the sample is represented by Vₘ, a set of sides thereof is represented by Eₘ (⊆Vₘ×Vₘ), a set of vertices in the screen structure of the processing target is represented by Vₙ, and a set of sides thereof is represented by Eₙ (⊆Vₙ×Vₙ). Note that in the case where the sides have orientations, they are distinguished separately from Eₘ or Eₙ. In addition, the screen components and vertices are not distinguished in the description. The screen structure of the sample and the screen structure of the processing target are represented by Sₘ=(Vₘ, Eₘ), Sₙ=(Vₙ, Eₙ) respectively.

In the comparison between the screen structures of the sample and the processing target, the vertex v (∈Vₘ) corresponding to each sample screen component is mapped to the vertex u (∈Vₙ) corresponding to at most one screen component of the processing target with no overlap. The mapping method of the vertices corresponds to the injective partial mapping (or total function) represented by an equation (1-1) and an equation (1-2). A set of the sample screen components mapped to any of the screen components of the processing target is represented by Def(f_{m, n}). In addition, a set of the screen components of the processing target mapped to the sample screen components is represented by Img(f_{m, n}). Note that Def(f_{m, n})=Img(f_{n, m}), and Def(f_{n, m})=Img(f_{m, n}) hold.

[Math. 1]

f_{m,n}:Vₘ [symbol] Vₙ (1-1)

f_{n,m}:Vₙ [symbol] Vₘ (1-2)

In the case where the screen structure is compared and a common partial structure is determined, the method is limited to methods in which the presence/absence of the side is maintained before and after the mapping for combinations of mapped vertices, i.e., methods that satisfy an equation (2-1) and an equation (2-2), among the mapping methods.

[Math. 2]

∀vᵢ,∀vⱼ∈Def(f_{m,n})(⊆Vₘ),(vᵢ,vⱼ)∈Eₘ⇔(f_{m,n}(vᵢ),f_{m,n}(vⱼ))∈Eₙ (2-2)

∀uᵢ,∀uⱼ∈Def(f_{n,m})(⊆Vₙ),(uᵢ,uⱼ)∈Eₙ⇔(f_{n,m}(uᵢ),f_{n,m}(uⱼ))∈Eₘ (2-2)

In the case where the screen structure is a directed ordered tree, it is possible to determine mapping methods \hat{ }f_{m, n} and \hat{ }f_{n, m} in which the number of screen components |Def(f_{m, n})| included in Def(f_{m, n}), and the number of screen components |Def(f_{n, m})| included in Def(f_{n, m}) are maximized in the calculation order of the product of the number of the screen components of the sample and the number of screen components of the processing target by using “algorithm for directed ordered tree” disclosed in Reference 1, for example. Reference 1: “Algorithms for Finding One of the Largest Common Subgraphs of Two Trees”, 1994, Sumio MASUDA, IEICE journal. A, basic⋅boundary 77 (3), 460-470, 1994-03-25)

Note that in Reference 1, all vertices are handled as being equivalent for each single vertex with the relationship with other vertices ignored, while in the present embodiment, screen components have at least the attribute representing the type, and the screen components of different types cannot be equivalent. Therefore, the mapping method is determined under a constraint condition in which only screen components that can be equivalent can be mapped.

Whether the mapping of the screen component is possible is determined by any of the following methods. ((2) is used when the option (β) 3 is applied)

(1) When the value of the attribute representing the type among the attributes of the screen components matches, it is determined that “mapping is possible”. Otherwise, it is determined that “mapping is not possible”.
(2) For each attribute of the screen component, the comparison rule to be applied is determined from among the comparison rules held in the screen component attribute comparison rule holding unit. The values of the attribute of the screen component of the sample and the attribute of the screen component of the processing target are compared with each other, and match or mismatch is determined based on the determined comparison rule as in Table 1. When all attributes are determined to be “match”, it is determined that the “mapping is possible” for the screen components. Otherwise, it is determined that the “mapping is not possible” for the screen components.

Note that the comparison rule to be applied is determined in the following priority order, for example. It should be noted that the comparison rule in which only one of “sample screen data ID” or “screen component ID” is not “(optional)” is not allowed. Priority 1: a comparison rule in which none of “sample screen data ID”, “screen component ID” or “attribute name” is “(optional)”, and there is a match with the ID and the attribute name of the screen component and the ID of the sample screen data m of the comparison target (when the option (β) 1-1-1 is applied).

Priority 2: a comparison rule in which neither “sample screen data ID” nor “screen component ID” is “(optional)”, and there is a match with the ID of the screen component and the ID of the sample screen data m of the comparison target (when the option (β) 1-1-1 is applied).
Priority 3: a comparison rule in which “attribute name” is not “(optional)”, and there is a match with the attribute name of the comparison target.
Priority 4: a comparison rule other than the priorities 1 to 3, in which there is a corresponding attribute name and ID of the screen component and ID of the sample screen data m of the comparison target.

In addition, in the present embodiment, the mapping method is determined under a constraint condition in which the screen component of the root of the screen structure of the sample can be mapped to only the screen component of the root of the screen structure of the processing target.

Further, in Reference 1, the mapping method f_{m, n} of partial structures is evaluated based on the mapped vertices, i.e., the number of screen components |Def(f_{m, n})| included in Def(f_{m, n}). Likewise, in the present embodiment, evaluation may be made based on the number of screen components included in the common partial structures, or evaluation methods reflecting the following viewpoints may be used.

Among the sample screen components, the screen component not to be subjected to masking is mapped to the screen component of the processing target in priority over other screen components. Therefore, when a set of screen components not to be subjected to masking is “˜Vₘ (⊆Vₘ)”, the mapping method f_{m, n} is evaluated based on the size of |Def(f_{m, n})∩˜Vₘ| (when the option (β) 1-1-1-2 is applied).

Note that the evaluation method of the mapping method is the same not only for the final mapping method for the entire screen structure of the sample and the entire screen structure of the processing target, but also for the mapping method (f, V in Equation (1-1) are replaced with f′, V′) for each partial structure with any of Vₘ′⊆Vₘ and Vₙ′⊆Vₙ as the vertex set handled in that determination. Therefore, by replacing only the evaluation method of the algorithm of Reference 1, the mapping method \hat{ }f_{m, n} with the best evaluation in the evaluation method is determined. In addition, the evaluation method itself does not depend on whether the screen composition is a graph structure or a tree structure.

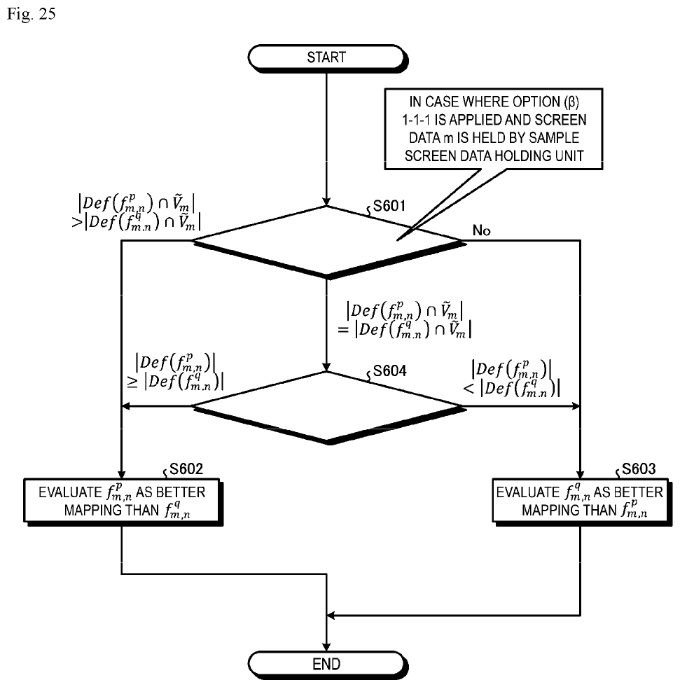

FIG. 25 is a flowchart of a process of evaluating a mapping method. With the branching at steps S601 and S604 in FIG. 25, the mapping methods f_{m, n}^{p} and f_{m, n}^{q} can be compared and the evaluation results of step S602 or S603 can be obtained.

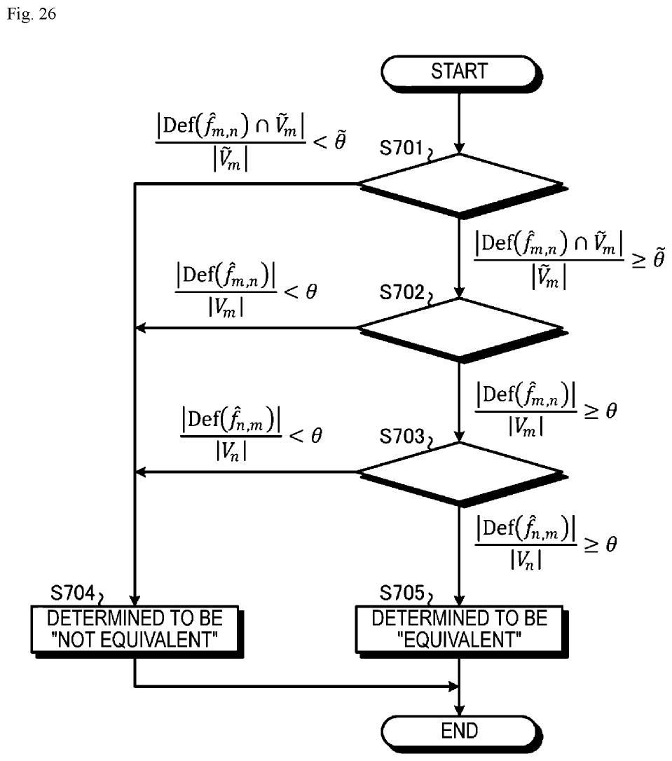

Whether the screen structures of the sample and the processing target are equivalent is determined by comparison with a predetermined threshold value for each evaluation viewpoint of the best mapping method \hat{ }f_{m, n} determined by the comparison. FIG. 26 is a flowchart of a process of determining the equivalence of screen structures. With the branching at steps S701, S702 and S703 in FIG. 26, the equivalence can be evaluated, and the result of step S704 or S705 can be obtained.

A threshold value common to all sample screen data may be used, or a threshold value determined for each sample screen data may be used (when the option (α) 5, or the option (β) 1-1-1-1 is applied).

While the equivalence of the screen structures of the sample and the processing target is determined after the best mapping method \hat{ }f_{m, n} is determined by comparison in the above-described process of comparing the screen structures of the sample and the processing target, the comparison process may be terminated at the time point when the value is found to be below the threshold value and may be determined to be “not equivalent”.

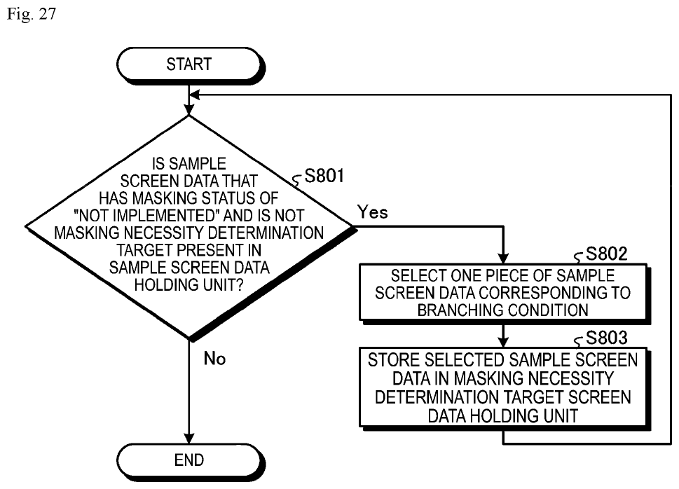

FIG. 27 is a flowchart of an entire process of listing screen data to be subjected to a masking necessity determination (the use case (α)). As illustrated in FIG. 27, when sample screen data that has the masking status of “not implemented” and is not the masking necessity determination target is present in the sample screen data holding unit (step S801, Yes), the masking apparatus proceeds to step S802. When the sample screen data is not present (step S801, No), the masking apparatus terminates the process. The masking apparatus selects one piece of sample screen data corresponding to the branching condition (step S802). The masking apparatus stores the selected sample screen data in the masking necessity determination target screen data holding unit (step S803), and returns to step S801.

In the use case (α), the masking apparatus sets, as the masking necessity determination target, all data having the masking status of “not implemented” in the sample screen data held by the sample screen data holding unit.

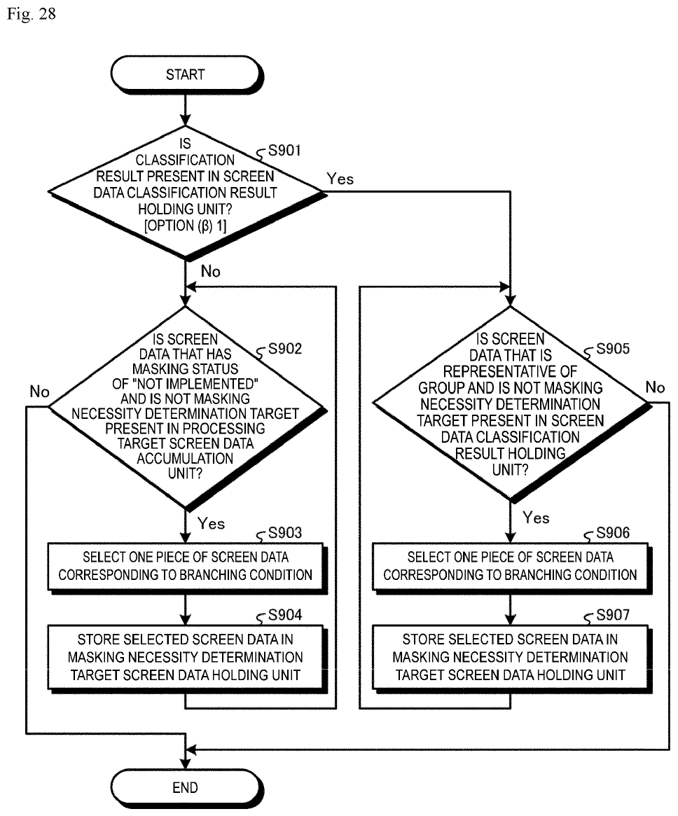

FIG. 28 is a flowchart of an entire process of listing screen data to be subjected to a masking necessity determination (the use case (β)). When a classification result is present in the screen data classification result holding unit [the option (β) 1] (step S901, Yes), the masking apparatus proceeds to step S905. When the classification result is not present (step S901, No), the masking apparatus proceeds to step S902.

When screen data that has the masking status of “not implemented” and is not the masking necessity determination target is present in the processing target screen data accumulation unit (step S902, Yes), the masking apparatus proceeds to step S903. When the screen data is not present (step S902, No), the masking apparatus terminates the process.

The masking apparatus selects one piece of screen data corresponding to the branching condition (step S903). The masking apparatus stores the selected screen data in the masking necessity determination target screen data holding unit (step S904), and returns to step S902.

When screen data that is the representative of the group and is not the masking necessity determination target is present in the screen data classification result holding unit (step S905, Yes), the masking apparatus proceeds to step S906. When the screen data is not present (step S905, No), the masking apparatus terminates the process.

The masking apparatus selects one piece of screen data corresponding to the branching condition (step S906). The masking apparatus stores the selected screen data in the masking necessity determination target screen data holding unit (step S907), and returns to step S905.

In the use case (β), the masking apparatus sets, as the masking necessity determination target, all data having the masking status of “not implemented” in the screen data accumulated in the processing target screen data accumulation unit. It should be noted that, when the option (β) 1 is applied, the screen data that is not selected as a representative of the group as a result of the classification by the screen data classification unit is excluded from the masking necessity determination target. The reason for this is that the masking necessity can be determined by examining, for each screen component, whether an equivalent screen component is present in the representative screen data of the same group, and examining, when the equivalent screen component is present, whether the masking necessity determination result of the equivalent screen component in the representative screen data is “necessary”. Note that whether the screen data is selected as the representative of the group as a result of the classification is determined by examining the classification result held by the screen data classification result holding unit.

Furthermore, when the option (β) 1-1-1 is applied, the screen data determined to be equivalent to any of the sample screen data as a result of the identification of the identification unit is also excluded from the masking necessity determination target. The reason for this is that the masking necessity can be determined by examining, for each screen component, whether an equivalent screen component is present in the equivalent sample screen data, and examining, when the equivalent screen component is present, whether the equivalent screen component of the sample is not to be subjected to masking. Note that whether the screen data is determined to be equivalent to any of the sample screen data is determined by examining the identification result held by the identification result holding unit.

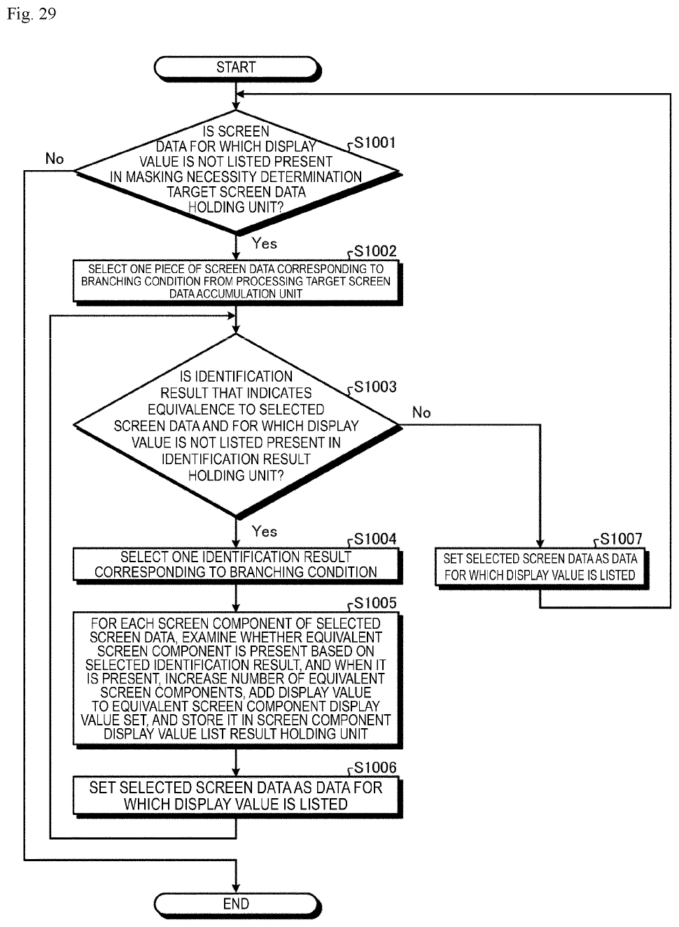

FIG. 29 is a flowchart of an entire process of listing a display value of a screen component (the use case (α)). As illustrated in FIG. 29, when screen data whose display value is not listed is present in the masking necessity determination target screen data holding unit (step S1001, Yes), the masking apparatus proceeds to step S1002. When the screen data is not present (step S1001, No), the masking apparatus terminates the process.

The masking apparatus selects one piece of screen data corresponding to the branching condition from the processing target screen data accumulation unit (step S1002). When an identification result that indicates equivalence to the selected screen data and for which the display value is not listed is present in the identification result holding unit (step S1003, Yes), the masking apparatus proceeds to step S1004. When the identification result is not present (step S1003, No), the masking apparatus proceeds to step S1007. The masking apparatus sets the selected screen data as data for which the display value is listed (step S1007), and returns to step S1001.

The masking apparatus selects one identification result corresponding to the branching condition (step S1004). The masking apparatus examines whether an equivalent screen component is present on the basis of the selected identification result for each screen component of the selected screen data, and when the equivalent screen component is present, the masking apparatus increases the number of equivalent screen components, adds the display value to equivalent screen component display value set, and stores the resultant equivalent screen component display value set in the screen component display value list result holding unit (step S1005). The masking apparatus sets the selected screen data as data for which the display value is listed (step S1006), and returns to step S1003.

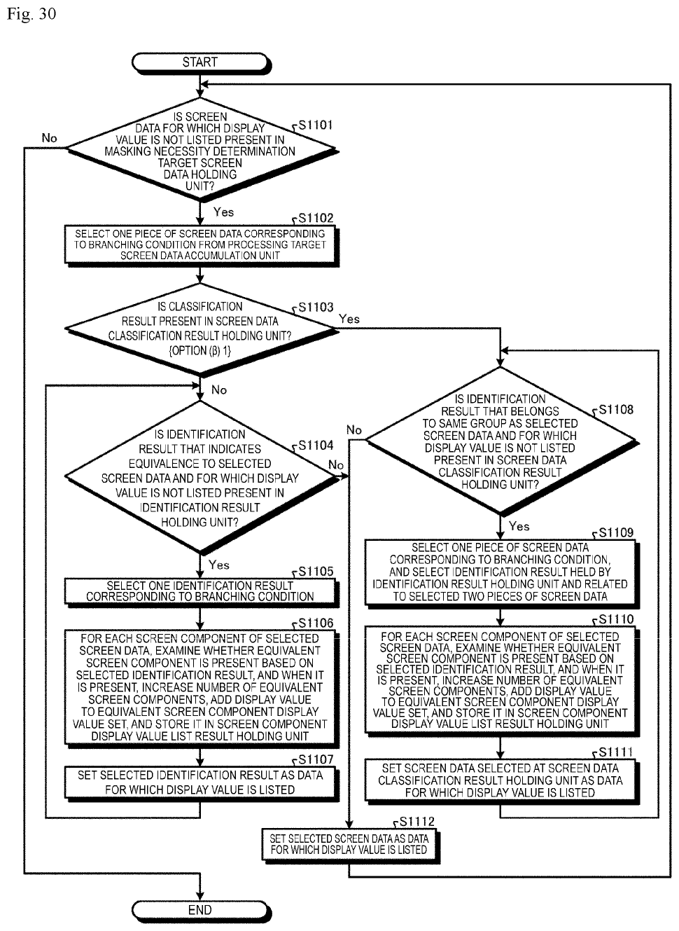

FIG. 30 is a flowchart of an entire process of listing a display value of a screen component (the use case (β)). As illustrated in FIG. 30, when screen data whose display value is not listed is present in the masking necessity determination target screen data holding unit (step S1101, Yes), the masking apparatus proceeds to step S1102. When the screen data is not present (step S1101, No), the masking apparatus terminates the process.

The masking apparatus selects one piece of screen data corresponding to the branching condition from the processing target screen data accumulation unit (step S1102). When a classification result is present in the screen data classification result holding unit [the option (β) 1] (step S1103, Yes), the masking apparatus proceeds to step S1108. When the classification result is not present (step S1103, No), the masking apparatus proceeds to step S1104.

When an identification result that indicates equivalence to the selected screen data and for which the display value is not listed is present in the identification result holding unit (step S1104, Yes), the masking apparatus proceeds to step S1105. When the identification result is not present (step S1104, No), the masking apparatus proceeds to step S1112. Here, the masking apparatus sets the selected screen data as data for which the display value is listed (step S1112), and returns to step S1101.

The masking apparatus selects one identification result corresponding to the branching condition (step S1105). The masking apparatus examines whether an equivalent screen component is present on the basis of the selected identification result for each screen component of the selected screen data, and when the equivalent screen component is present, the masking apparatus increases the number of equivalent screen components, adds the display value to equivalent screen component display value set, and stores the resultant equivalent screen component display value set in the screen component display value list result holding unit (step S1106). The masking apparatus sets the selected screen data as data for which the display value is listed (step S1107), and returns to step S1104.

When an identification result that belongs to the same group as the selected screen data and for which the display value is not listed is present in the screen data classification result holding unit (step S1108, Yes), the masking apparatus proceeds to step S1109. When the identification result is not present (step S1108, No), the masking apparatus proceeds to step S1112.

The masking apparatus selects one piece of screen data corresponding to the branching condition, and selects the identification result held by the identification result holding unit and related to the selected two pieces of screen data (step S1109). The masking apparatus examines whether an equivalent screen component is present on the basis of the selected identification result for each screen component of the selected screen data, and when the equivalent screen component is present, the masking apparatus increases the number of equivalent screen components, adds the display value to equivalent screen component display value set, and stores the resultant equivalent screen component display value set in the screen component display value list result holding unit (step S1110). The masking apparatus sets the screen data selected at the screen data classification result holding unit, as data for which the display value is listed (step S1111), and returns to step S1108.

A supplementary description regarding FIGS. 29 and 30 is made below. In the screen component display value list process, first, all equivalent screen data is determined for each screen data to be subjected to the masking necessity determination. It is achieved by examining the identification result held by the identification result holding unit, and acquiring equivalent one from the screen data accumulated in the processing target screen data accumulation unit.

It should be noted that, when the option (β) 1 is applied in the use case (β), it is achieved alternatively by examining the classification result held by the screen data classification result holding unit, and acquiring one classified in the same group from the screen data accumulated in the processing target screen data accumulation unit.

Next, whether an equivalent screen component is present in equivalent each screen data is examined for each screen component of each screen data to be subjected to the masking necessity determination, and when the equivalent screen component is present, the number thereof (hereinafter referred to as “number of equivalent screen components”) is increased, and the display value of the equivalent screen component is added to a set for holding the display value with no overlap (hereinafter referred to as “equivalent screen component display value set”).

It should be noted that, when the option (α) 4 or the option (β) 4 is applied, this process is omitted for screen components of the type such as a list box, for which the display value obviously can only have a limited candidate value.

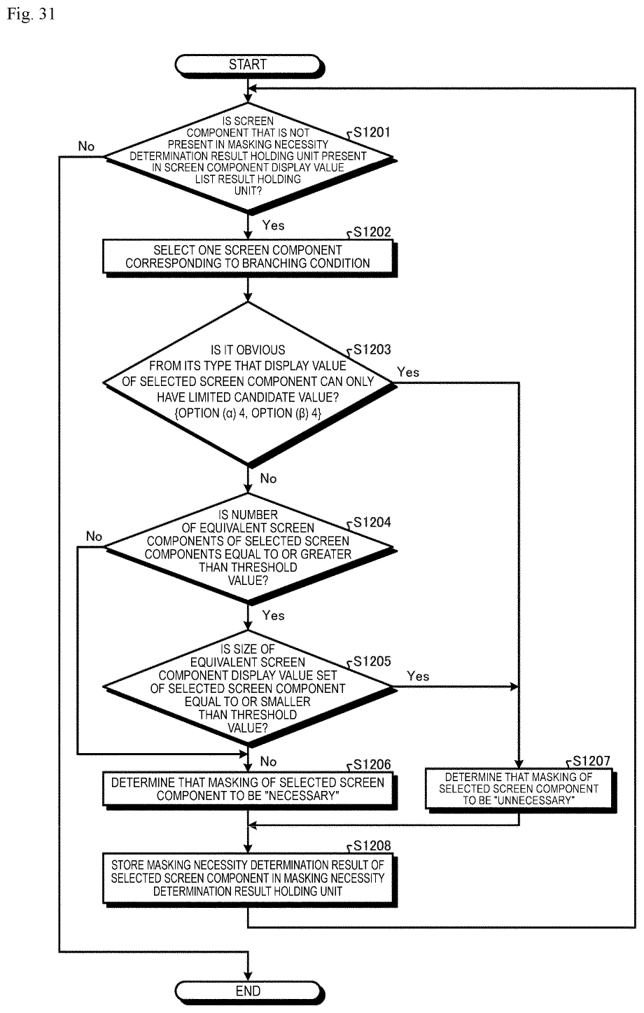

FIG. 31 is a flowchart of an entire process of determining the necessity of masking. As illustrated in FIG. 31, when a screen component that is not present in the masking necessity determination result holding unit is present in the screen component display value list result holding unit (step S1201, Yes), the masking apparatus proceeds to step S1202. When the screen component is not present (step S1201, No), the masking apparatus terminates the process.

The masking apparatus selects one screen component corresponding to the branching condition (step S1202). When it is obvious, from its type, that the selected screen component is a component for which the display value can only have a limited candidate value [the option (α) 4, (β) 4] (step S1203, Yes), the masking apparatus proceeds to step S1207. When it is not obvious (step S1203, No), the masking apparatus proceeds to step S1204. The masking apparatus determines that the masking of the selected screen component is “not necessary” (step S1207), and proceeds to step S1208.

When the number of equivalent screen components of the selected screen component is equal to or greater than its threshold value (step S1204, Yes), the masking apparatus proceeds to step S1205. When the number is not equal to or greater than the threshold value (step S1204, No), the masking apparatus proceeds to step S1206.

When the size of the equivalent screen component display value set of the selected screen component is smaller than its threshold value (step S1205, Yes), the masking apparatus proceeds to step S1207. When the size is not smaller than the threshold value (step S1205, No), the masking apparatus proceeds to step S1206. The masking apparatus determines that the masking of the selected screen component is “necessary” (step S1206). The masking apparatus stores the masking necessity determination result of the selected screen component in the masking necessity determination result holding unit (step S1208), and returns to step S1201.

The masking apparatus determines the masking necessity of the display value of the screen component by using the number of equivalent screen components and the equivalent screen component display value set. Here, information that has many variations and that has a value different depending on the case of the screen display target and the like is information that can directly identify customers and the like, and is therefore confidential information in many cases. On the other hand, information that has less variations and has the same value among multiple cases is information that makes it difficult to directly identify customers and the like, and is therefore not confidential information in many cases. On the other hand, the operation setting of the program intended for automation or support of the terminal operation needs to be repeatedly applicable to various cases, and therefore information that less depends on the case of the screen display target and has less variations is used. In addition, also in classifying information in the process of understanding and analyzing actual business conditions, information with little variations is used so that the number of classifications does not become too large.

Specifically, the necessity of masking of the display value is determined in the following manner by utilizing the characteristics of information that requires masking and information that does not require masking.

(1) Case where Number of Equivalent Screen Components is Equal to or Greater than Predetermined Threshold Value λ
When the size of the equivalent screen component display value set, i.e., the number of the variations of the display value is examined and the number of the variations of the display value is equal to or greater than the predetermined threshold value, the masking of the display value of the screen component is determined to be “necessary”. When the size of the equivalent screen component display value set, i.e., the number of the variations of the display value is examined and the number of the variations of the display value is smaller than the predetermined threshold value, the masking of the display value of the screen component is determined to be “not necessary”.
(2) Case where Number of Equivalent Screen Components is Smaller than Predetermined Threshold Value λ
The masking of the display value of the screen component is determined to be “necessary”. Note that the reason for this is that the variation of the display value cannot be sufficiently examined from the screen data that can be used at the time point when the process of the present embodiment is executed, and therefore it is determined to be subjected to masking for the safety purpose.

It should be noted that, when the option (α) 4 or the option (β) 4 is applied, for screen components, such as a list box, for which it is clear from the type of the screen component that the display value obviously can only have a limited candidate value, it is determined that the masking is “not necessary” without comparing the list result with a predetermined threshold value.

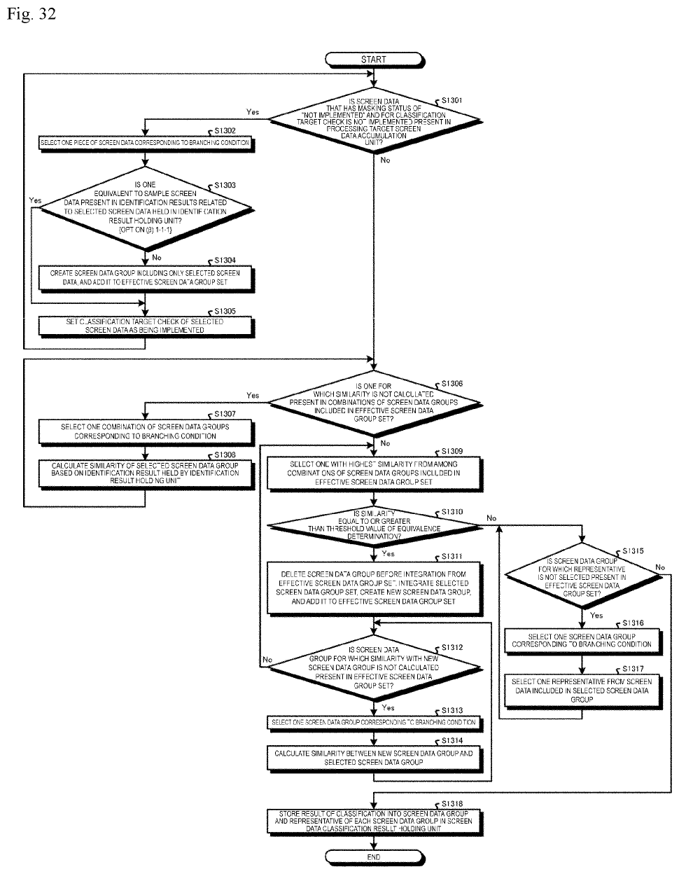

FIG. 32 is a flowchart of an entire process of classifying screen data. As illustrated in FIG. 32, when screen data that has the masking status of “not implemented” and for which the classification target check is not implemented is present in the processing target screen data accumulation unit (step S1301, Yes), the masking apparatus proceeds to step S1302. When the screen data that is not present, the masking apparatus proceeds to step S1306.

The masking apparatus selects one piece of screen data corresponding to the branching condition (step S1302). When data equivalent to sample screen data is present in the identification result that is related to the selected screen data and is held by the identification result holding unit [the option (β) 1-1-1] (step S1303, Yes), the masking apparatus proceeds to step S1305. When the equivalent data is not present (step S1303, No), the masking apparatus proceeds to step S1304.

The masking apparatus creates a screen data group including only the selected screen data, and adds the selected screen data to an effective screen data group set (step S1304). The masking apparatus sets the classification target check of the selected screen data as being implemented (step S1305), and returns to step 1301.

When a combination for which the similarity is not calculated is present in the combinations of the screen data group included in the effective screen data group set (step S1306, Yes), the masking apparatus proceeds to step S1307. When the combination is not present (step S1306, No), the masking apparatus proceeds to step S1309.

The masking apparatus selects one combination of the screen data groups corresponding to the branching condition (step S1307). The masking apparatus calculates the similarity of the selected screen data group on the basis of the identification result held by the identification result holding unit (step S1308), and returns to step S1306.

The masking apparatus selects one with the highest similarity from among the combinations of the screen data group included in the effective screen data group set (step S1309). When the similarity is equal to or greater than the threshold value of the equivalence determination (step S1310, Yes), the masking apparatus proceeds to step S1311. When the similarity is not equal to or greater than the threshold value (step S1310, No), the masking apparatus proceeds to step S1315.

The masking apparatus deletes the screen data group before the integration from the effective screen data group set, integrates the selected screen data group set, creates a new screen data group, and adds the group to the effective screen data group set (step S1311).

When a screen data group for which the similarity with the new screen data group is not calculated is present in the effective screen data group set (step S1312, Yes), the masking apparatus proceeds to step S1313. When the screen data group is not present (step S1312, No), the masking apparatus returns the process to step S1309.

The masking apparatus selects one screen data group corresponding to the branching condition (step S1313). The masking apparatus calculates the similarity between the new screen data group and the selected screen data group (step S1314), and returns to step 1312.

When a screen data group for which the representative is not selected is present in the effective screen data group set (step S1315, Yes), the masking apparatus proceeds to step S1316. When the screen data group is not present (step S1315, No), the masking apparatus proceeds to step 1318. The masking apparatus selects one screen data group corresponding to the branching condition (step S1316). The masking apparatus selects one representative from the screen data included in the selected screen data group (step S1317), and returns to step S1315. The masking apparatus stores the result of classification into the screen data group and the representative of each screen data group in the screen data classification result holding unit (step S1318).

In the screen data classification process, first, data having the masking status of “not implemented” in the screen data accumulated in the processing target screen data accumulation unit is set as the classification target. It should be noted that the masking apparatus excludes, from the classification target, the screen data determined to be equivalent to any of the sample screen data by the identification unit (when the option (β) 1-1-1 is applied). Note that whether the data has been determined to be equivalent to any of the sample screen data can be examined based on the identification result held by the identification result holding unit.

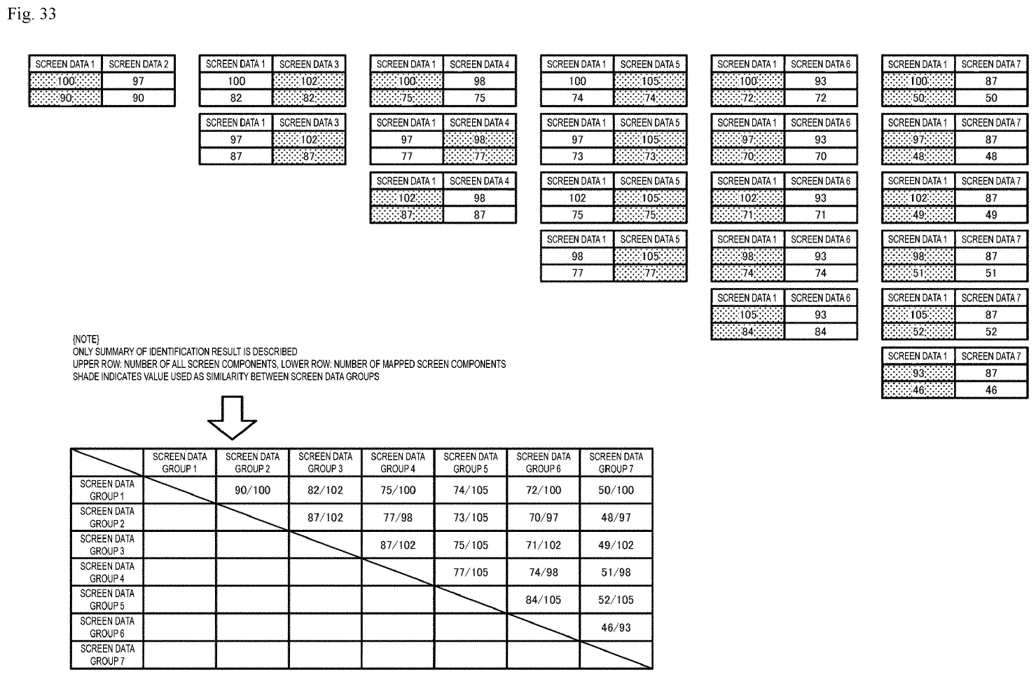

Next, the masking apparatus creates screen data groups each including one piece of screen data of the classification target, and adds the screen data groups to a set (hereinafter referred to as “effective screen data group set”) of screen data groups that are effective at each time point in the process. In addition, assuming that given two screen data groups m and n respectively include pieces of screen data m and n, the similarity θ_{m, n} (θ_{n, m}) between the screen data groups is determined based on Equation (3) as illustrated in FIG. 33. FIG. 33 is a diagram illustrating an example in which the similarity between screen data groups is determined from the identification result between screen data.

$$\begin{matrix}[ Math . 3 ] & \\ {θ}_{m , n} = min \{ \frac{\vert Def ( {\hat{f}}_{m , n} ) \vert}{\vert {V}_{m} \vert} , \frac{\vert D ef ( {\hat{f}}_{n , m} ) \vert}{\vert {V}_{n} \vert} \} & ( 3 )\end{matrix}$$

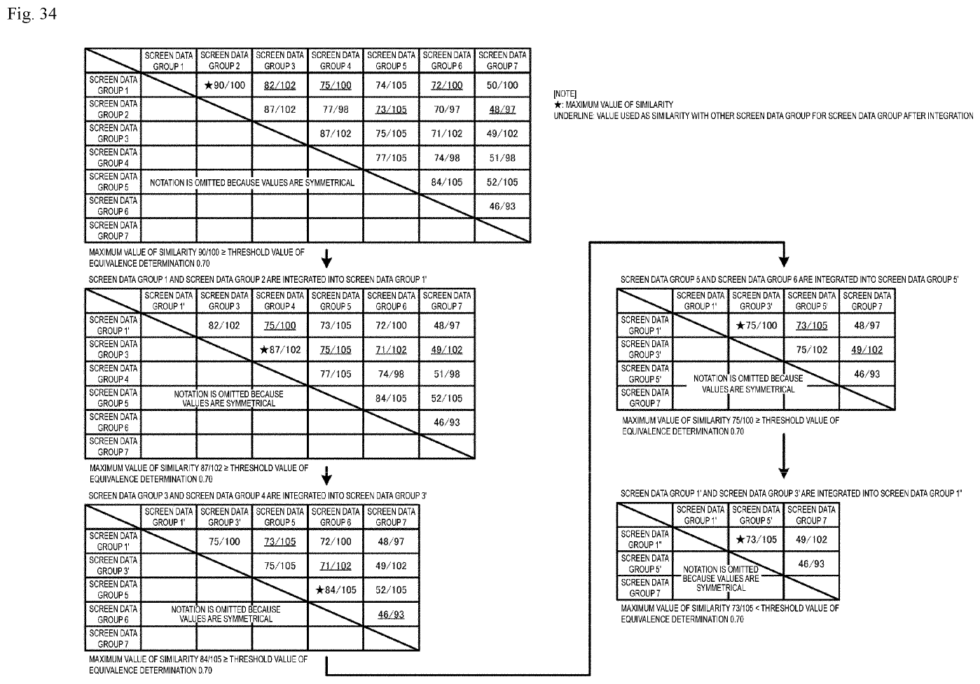

Subsequently, as illustrated in FIG. 34, the masking apparatus repeats the processes (1) to (4) to integrate the groups such that only equivalent screen data is included in the same group and to reduce the number of groups while increasing the screen data in the group. FIG. 34 is a diagram illustrating an example of classifying screen data.

(1) From among the combinations of the screen data groups included in the effective screen data group set, a combination with the highest similarity between the screen data groups is found. In the following description, the screen data groups with the highest similarity are assumed to be screen data groups \hat{ }m and \hat{ }n.
(2) When θ_{\hat{ }m,\hat{ }n} is compared with the threshold value θ used also for determining the equivalence in the screen and screen component identification processes and is smaller than the threshold value (θ_{\hat{ }m, \hat{ }n}<θ), the subsequent processes are terminated, and the selection of representative screen data described later is performed since further integration of the screen data group causes the non-equivalent screen data to be included in the same group. When θ_{\hat{ }m, \hat{ }n} is equal to or greater than the threshold value (θ_{\hat{ }m, \hat{ }n}>θ), the process is returned to the process (1) after performing the subsequent processes (3) and (4) of integrating screen data groups.
(3) A new screen data group m′ that includes the screen data included in the screen data groups \hat{ }m and \hat{ }n is created. The screen data groups \hat{ }m and \hat{ }n are deleted from the effective screen data group set, and the screen data group m′ is added instead.
(4) A similarity θ_{m′, k} (=θ_{k, m′}) between the screen data group m′ and other given screen data group k included in the effective screen data group set is determined based on Equation (4).

[Math. 4]

θ_{m′,k}=min{θ_{\hat{m},k},θ_{\hat{n},k}} (4)

The above-described method for classifying the screen data into groups corresponds to a method in which, with the value obtained by subtracting the similarity from 1 as the distance, the maximum distance method is used for the calculation of the inter-cluster distance in the agglomerative hierarchical clustering in the clustering method. However, other distances may be defined, calculation methods for the inter-cluster distance may be used, and other various clustering methods may be used.

Through the process up to this point, the effective screen data group set includes a screen data group as a result of classification in which the equivalent screen data is classified in the same group while the number of groups is reduced as much as possible. Representative screen data is selected for each of the screen data groups.

Specifically, for example, for each screen component for each screen data, a process of counting the number of equivalent screen components in the other screen data included in the same group, i.e., the number of equivalent screen components, and further counting the number of screen components whose number of equivalent screen components is equal to or greater than a predetermined threshold value φ (hereinafter referred to as “φ-number of common screen components”) is performed, and the screen data with the largest φ-number of common screen components is set as the representative of the group. In particular, when φ is set as the predetermined threshold value λ that is used in the masking necessity determination process (hereinafter referred to as “representative screen data selection method 1”), it is possible to minimize the screen components that are determined to be subjected to masking for the reason that the variation of the display value cannot be sufficiently examined from the screen data that can be used at the time point of executing the process of the present disclosure.

Alternatively, when φ is set to 1 (hereinafter referred to as “representative screen data selection method 2”), the necessity of masking of the screen component in the screen data included in the same group can be confirmed most and can be individually changed at the modification unit even when screen data subjected to displaying and/or manual operation is only one piece of representative screen data for each group.

Alternatively, for each screen data m, the sum of the number of screen components |Def(\hat{ }f_{m, n}) that is mapped by the best mapping method \hat{ }f_{m, n} with other screen data n included in the same group g is determined (Equation (5)), and the screen data in which this value is maximum is set as the representative of the group.

$$\begin{matrix}[ Math . 5 ] & \\ {{\sum }_{n ∈ g}}_{n \neq m} \vert Def ( {\hat{f}}_{m , n} ) \vert & ( 5 )\end{matrix}$$

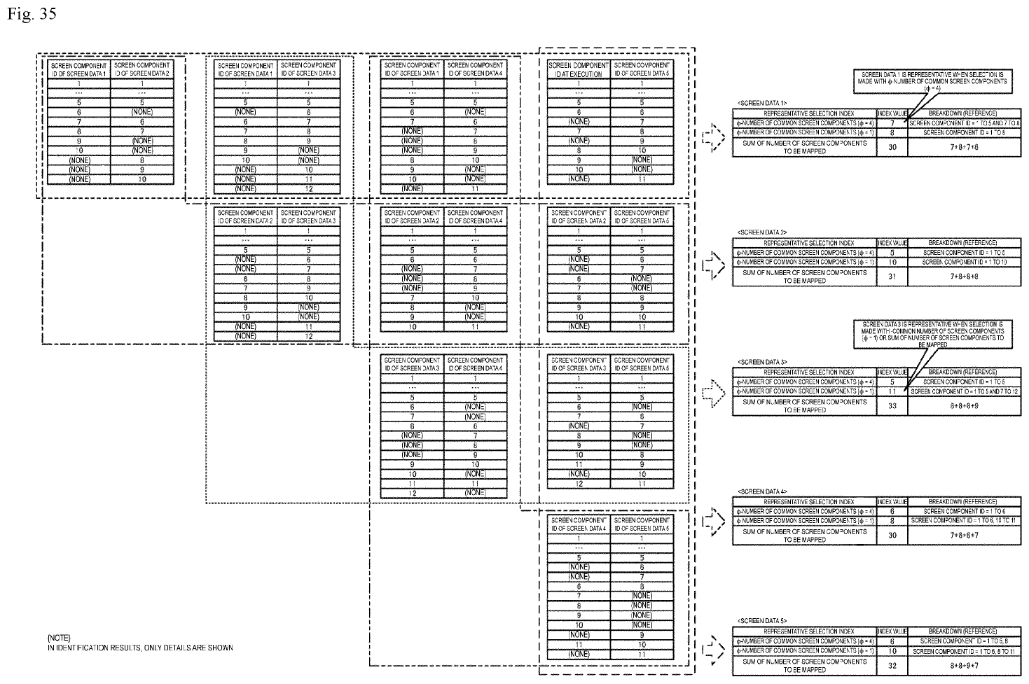

In this manner, for each screen component for the screen data other than the representative, the processes up to the masking can be performed without examining the equivalent screen component in other screen data included in the same group, and the approximation of the “representative screen data selection method 1” or the “representative screen data selection method 2” can be achieved while the computational quantity is reduced. FIG. 35 is a diagram illustrating an example of selecting a representative of a group.

While a method for selecting representative screen data has been described above specifically for masking of the screen display content, another method may be used in accordance with another general-purpose clustering method used as a method for classifying screen data into groups.

The masking apparatus according to the embodiment described so far has the following features.

### Features of Masking Apparatus in Use Case (α)

After the creation of the operation setting of the program intended for automation or support of the terminal operation, the masking apparatus performs the masking necessity determination and the masking of each sample screen component by comparing each screen data of the sample and a plurality of pieces of screen data of the processing target acquired during operation.

In addition, when comparing a plurality of pieces of screen data of the processing target and the screen data of the sample, the masking apparatus identifies the screen and the screen component, and determines all equivalent screen data. Thereafter, for each screen component of the sample, the masking apparatus performs the masking necessity determination and the masking by determining the variation of the display value and the number of equivalent screen components in other equivalent screen data, and comparing them with predetermined threshold values.

In addition, the masking apparatus displays the masking necessity determination result in a form easily understandable to people. In addition, through a manual operation, the masking apparatus changes the threshold value used for the masking necessity determination, redoes the determination, and displays the determination result after the change again. Alternatively, through a manual operation, the masking apparatus individually changes the masking necessity of the screen component.

In addition, in the identification of the screen and the screen component, the masking apparatus determines the equivalence of the screen and the screen component also in consideration of whether the relationship with other screen components in respective screen structures is the same between the screen component in the screen structure of the sample and the screen component in the screen structure of the processing target that have the same attribute value and could be equivalent.

More specifically, the masking apparatus compares the screen structures of the sample and the processing target, and determines the common partial structure such that the best evaluation of the mapping method is obtained based on the number of them mapped to the screen component of the processing target in the all screen components of the sample. Thereafter, the masking apparatus determines the equivalence of the screen and the screen component by comparing, with a predetermined threshold value, the occupancy ratio of that number in the number of the sample screen components and the occupancy ratio of that number in the number of the screen components of the processing target.

In addition, the masking apparatus controls the determination of the equivalence in accordance with the screen of the application target by designating the comparison rule for only the attribute of the screen that requires individual adjustment of the method for determining match or mismatch.

Features of Masking Apparatus in Use Case (β)

The masking apparatus identifies the screen and the screen component, and determines all equivalent screen data in the comparison between each screen data in an operation log and other remaining screen data. Thereafter, the masking apparatus performs the masking necessity determination and the masking by determining the variation of the display value and the number of equivalent screen components in other equivalent screen data for each screen component of each screen data, and comparing them with predetermined threshold values.

For screen data in operation logs, the masking apparatus classifies the screen data into groups such that the equivalent screen data is classified in the same group while the number of groups is reduced as much as possible. In addition, the masking apparatus selects one piece of representative screen data for each group. The masking apparatus performs the masking necessity determination only for each screen component of the representative screen data of each group instead of performing the masking necessity determination for each screen component of each screen data. For the screen data other than the representative, the masking apparatus specifies the screen component to be subjected to masking on the basis of the masking necessity determination result for the representative screen data of the same group.

The masking apparatus displays the masking necessity determination result in a form easily understandable to people. In addition, through a manual operation, the masking apparatus changes the threshold value used for the masking necessity determination, redoes the determination, and displays the determination result after the change again. Alternatively, through a manual operation, the masking apparatus individually changes the masking necessity of the screen component.

In the case where the masking is repeatedly performed, the masking apparatus stores the screen data, the masking necessity determination result related to the screen data, and the manual individual change result, as sample screen data, and reuses the data for the subsequent masking. That is, in the subsequent masking, the masking apparatus compares each screen data in the operation log with the sample screen data before comparing the screen data with the other remaining screen data, and when the screen data is equivalent, the masking apparatus specifies the screen component to be subjected to masking on the basis of the masking necessity determination result related to the sample screen data.

In the identification of the screen and the screen component, the masking apparatus determines the equivalence of the screen and the screen component also in consideration of whether the relationship with other screen components in respective screen structures is the same between the screen component of one screen structure and the screen component of the other screen structure that have the same attribute value and could be equivalent.

More specifically, the masking apparatus compares one screen structure and the other screen structure and determines the common partial structure such that the best evaluation of the mapping method is obtained on the basis of the number of screen components of one screen structure to be mapped to screen components of the other structure, and the number of screen components of the sample not to be subjected to masking and to be mapped to screen components of the other structure when one of them is the sample, and the like. Thereafter, the masking apparatus determines the equivalence of the screen and the screen component by comparing, with a predetermined threshold value, the occupancy ratio of that number in the number of the screen components on one side, the occupancy ratio of that number in the number of the screen components on the other side, and further, the occupancy ratio of that number in the number of the screen components of the sample not to be subjected to masking when one of them is the sample.

The masking apparatus controls the determination of the equivalence in accordance with the screen of the application target by designating the comparison rule only for the screen, the screen component and the attributes thereof that require individual adjustment of the method for determining match or mismatch.

In addition, according to the embodiment, the following effects can be achieved. Specifically, it is possible to perform the masking without necessarily manually performing the selection of the screen data to be set as the sample and the designation of the screen component that requires masking of the display value, even under the following conditions that are difficult to handle with the related-art techniques.

Even with equivalent screens, the attribute value of the screen component and the screen structure vary depending on the displayed case and/or the implementation status of the operation. In the screen component information that can be acquired, the invariant attribute is limited to the type of the screen component and the like, and each screen component cannot be uniquely identified in the screen even by using the screen component to be subjected to masking or not to be subjected to masking and the attribute of its ancestors or a combination of a plurality of attributes. The arrangement of the screen components on a two-dimensional plane varies depending on the size of the screen and/or the volume of the display content of each screen component. The determination condition of the equivalence of the screen component to be subjected to masking or not to be subjected to masking need not necessarily be manually created for each screen and/or each screen component.

System Configuration, Etc.

Further, respective components of each of the illustrated apparatuses are functionally conceptual ones, and are not necessarily physically configured as illustrated in the figures. Specifically, the specific form of the distribution and integration of each apparatus is not limited to the form illustrated in the figures, and the entirety or a portion of the form may be configured by functional or physical distribution and integration manner in any unit in accordance with various loads, use conditions, and the like. Further, all or some of processing functions performed by each device may be implemented by a CPU and a program that is analyzed and executed by the CPU, or may be realized as hardware based on a wired logic.

Among processes described in the present embodiment, all or some of processes described as being automatically performed can be manually performed, or all or some of processes described as being manually performed may be automatically performed by well-known methods. In addition, information including the processing procedures, control procedures, specific names, and various types of data or parameters in the above description and figures may be freely changed unless otherwise described.

Program

As an embodiment, the masking apparatus 10 can be implemented by installing a masking program that executes the above-mentioned masking process as package software or online software in a desired computer. For example, by causing the information processing apparatus to execute the above-mentioned masking program, the information processing apparatus can function as the masking apparatus 10. The information processing apparatus referred to herein includes a desktop personal computer or notebook personal computer. Further, a mobile communication terminal such as a smart phone, a mobile phone, or a personal handyphone system (PHS), or a slate terminal such as a personal digital assistant (PDA), for example, is included in a category of the information processing apparatus.

In addition, the masking apparatus 10 may be implemented as a masking server apparatus that provides a service related to the above-described masking process to a client that is a terminal apparatus used by the user. For example, the masking server apparatus is implemented as a server apparatus that provides a masking service with an operation log as an input and a masking result as an output. In this case, the masking server apparatus may be implemented as a web server, or as a cloud that provides services related to the above-described masking process through outsourcing.

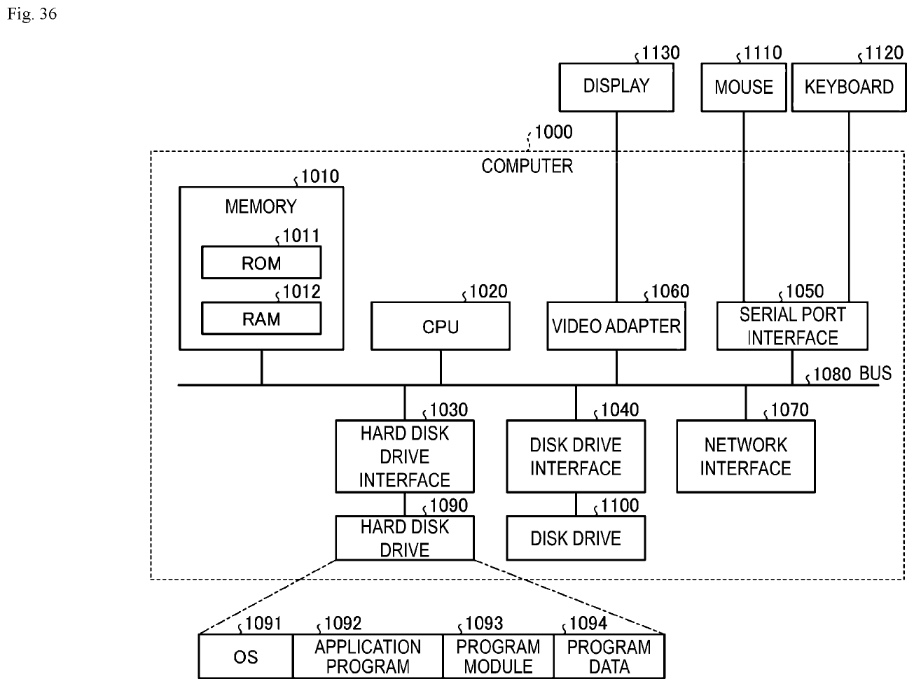

FIG. 36 is a diagram illustrating an example of a computer that executes a masking program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. Each of these units is connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. Specifically, the program that defines each process of the masking apparatus 10 is implemented as the program module 1093 that describes the code that can be executed by a computer. The program module 1093 is stored in, for example, the hard disk drive 1090. For example, the program module 1093 for executing the same process as the functional configuration in the masking apparatus 10 is stored in hard disk drive 1090. The hard disk drive 1090 may be replaced with an SSD.

Further, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the embodiment described above.

The program module 1093 and the program data 1094 are not limited to being stored in the hard disk drive 1090 and, for example, may be stored in a detachable storage medium and read by the CPU 1020 via the disk drive 1100 or the like. Alternatively, the program module 1093 and the program data 1094 may be stored in other computers connected via a network (a local area network (LAN), a wide area network (WAN), or the like). In addition, the program module 1093 and the program data 1094 may be read by the CPU 1020 from another computer through the network interface 1070.

### REFERENCE SIGNS LIST

10, 10a Masking apparatus
20 Support apparatus
101a Operation log accumulation unit
102a, 204 Processing target screen data accumulation unit
103a, 201 Sample screen data holding unit
104a, 202 Screen attribute comparison rule holding unit
105a, 203 Screen component attribute comparison rule holding unit
101, 106a Identification unit
107a Screen data classification unit
102, 108a Masking necessity determination target screen data list unit
103, 109a Screen component display value list unit
104, 110a Masking necessity determination unit
105, 111a Modification unit
106, 112a Identification result holding unit
113a Screen data classification result holding unit
107, 114a Masking necessity determination target screen data list result holding unit
108, 115a Screen component display value list result holding unit
109, 116a Masking necessity determination result holding unit
110, 117a Masking execution unit

1. A masking apparatus comprising:
an identification unit, including one or more processors, configured to identify a screen and screen components included in individual screen data of first screen data serving as a reference and one or more pieces of second screen data serving as a processing target;
a specifying unit, including one or more processors, configured to specify third screen data on a basis of the screen and the screen components that are identified, the third screen data being data equivalent to the first screen data in the one or more pieces of second screen data; and
a determination unit, including one or more processors, configured to determine necessity of masking of each screen component included in the first screen data on a basis of the third screen data.

2. The masking apparatus according to claim 1, wherein
the determination unit is configured to determine the necessity of masking of each screen component included in the first screen data on a basis of the number of screen components that are included in the first screen data and are equivalent to a screen component included in the third screen data, and the number of variations of a display value of the screen component included in the first screen data on a basis of a display value of the screen component included in the third screen data.

3. The masking apparatus according to claim 1, wherein
the identification unit is configured to identify a screen and screen components included in individual screen data of first screen data prepared as a sample and one or more pieces of second screen data serving as a processing target, or first screen data included in an operation log and second screen data that is screen data included in the operation log and is different from the first screen data.

4. The masking apparatus according to claim 3, further comprising:
a classification unit, including one or more processors, configured to classify the second screen data into a plurality of groups, and select representative screen data for each group, wherein
the specifying unit and the determination unit are configured to perform a process using a classification result obtained by the classification unit.

5. The masking apparatus according to claim 1, wherein
when the third screen data is screen data for which a determination result of the necessity of masking is stored, the determination unit is configured to determine the necessity of masking of each screen component included in the first screen data in accordance with the determination result that is stored.

6. A masking method executed by a masking apparatus, the method comprising:
identifying a screen and screen components included in individual screen data of first screen data serving as a reference and one or more pieces of second screen data serving as a processing target;
specifying third screen data on a basis of the screen and the screen components that are identified, the third screen data being data equivalent to the first screen data in the one or more pieces of second screen data; and
determining necessity of masking of each screen component included in the first screen data on a basis of the third screen data.

7. A non-transitory computer readable medium storing one or more instructions causing a computer to execute:
identifying a screen and screen components included in individual screen data of first screen data serving as a reference and one or more pieces of second screen data serving as a processing target;
specifying third screen data on a basis of the screen and the screen components that are identified, the third screen data being data equivalent to the first screen data in the one or more pieces of second screen data; and
determining necessity of masking of each screen component included in the first screen data on a basis of the third screen data.

8. The masking method according to claim 6, comprising:
determining the necessity of masking of each screen component included in the first screen data on a basis of the number of screen components that are included in the first screen data and are equivalent to a screen component included in the third screen data, and the number of variations of a display value of the screen component included in the first screen data on a basis of a display value of the screen component included in the third screen data.

9. The masking method according to claim 6, comprising:
identifying a screen and screen components included in individual screen data of first screen data prepared as a sample and one or more pieces of second screen data serving as a processing target, or first screen data included in an operation log and second screen data that is screen data included in the operation log and is different from the first screen data.

10. The masking method according to claim 9, further comprising:
classifying the second screen data into a plurality of groups, and select representative screen data for each group; and
performing a process using a classification result obtained by the classification.

11. The masking method according to claim 6, comprising:
when the third screen data is screen data for which a determination result of the necessity of masking is stored, determining the necessity of masking of each screen component included in the first screen data in accordance with the determination result that is stored.

12. The non-transitory computer readable medium according to claim 7, wherein the one or more instructions cause the computer to execute:
determining the necessity of masking of each screen component included in the first screen data on a basis of the number of screen components that are included in the first screen data and are equivalent to a screen component included in the third screen data, and the number of variations of a display value of the screen component included in the first screen data on a basis of a display value of the screen component included in the third screen data.

13. The non-transitory computer readable medium according to claim 7, wherein the one or more instructions cause the computer to execute:
identifying a screen and screen components included in individual screen data of first screen data prepared as a sample and one or more pieces of second screen data serving as a processing target, or first screen data included in an operation log and second screen data that is screen data included in the operation log and is different from the first screen data.

14. The non-transitory computer readable medium according to claim 12, wherein the one or more instructions cause the computer to execute:
classifying the second screen data into a plurality of groups, and select representative screen data for each group; and
performing a process using a classification result obtained by the classification.

15. The non-transitory computer readable medium according to claim 7, wherein the one or more instructions cause the computer to execute:
when the third screen data is screen data for which a determination result of the necessity of masking is stored, determining the necessity of masking of each screen component included in the first screen data in accordance with the determination result that is stored.
